(19) United States
(12) Patent Application Publication
(10) Pub. No.: US 2019/0364895 A1
(43) Pub. Date: Dec. 5, 2019

(54) ANTIMICROBIAL COMPOUNDS OR PRECURSORS THEREOF COMRPISING ONE OR MORE CATIONIC CENTERS AND A COATING-INCORPORATION GROUP

(71) Applicant: Exigence Technologies Inc., Winnipeg (CA)

(72) Inventors: Harshita Chaudhary, Winnipeg (CA); Gurmeet Bindra, Winnipeg (CA); Marcelo Dubiel, Winnipeg (CA); Zachary Wolff, Winnipeg (CA)

(21) Appl. No.: 16/333,111

(22) PCT Filed: Apr. 19, 2017
(86) PCT No.: PCT/CA2017/050482

§ 371 Date: Mar. 13, 2019

Related U.S. Application Data
(60) Provisional application No. 62/393,757, filed on Sep. 13, 2016.

(51) Int. Cl. A01N 43/40; A01N 57/24; A01N 43/50; A01N 33/12

(52) U.S. Cl. CPC A01N 43/40; A01N 33/12; A01N 43/50; A01N 57/24

(57) ABSTRACT

The present disclosure describes monomeric compounds and polymeric compounds that comprise at least one of the monomeric compounds and compositions that can be included in a coating composition for coating a substrate. The coated substrate may have biocidal activity or the potential for increased biocidal activity. The potential for increased biocidal activity may be realized by exposing the coated substrate to one or more further agents, such as one or more halogens. The monomer compound comprises (i) one or more cationic centers, (ii) an N-halamine precursor group, and (iii) at least one coating-incorporation group (CIG). The CIG bonds with another component within the coating composition or alternatively the CIG may bond with a component of the substrate. The CIG of the composition may incorporate the monomer into the coating composition, may incorporate the coating composition onto the substrate, or the CIG may perform both functions.

### TECHNICAL FIELD

This disclosure generally relates to compounds having biocidal properties and/or a potential for increased biocidal properties and to coating compositions comprising said compounds. The coating compositions are for coating substrates to provide biocidal properties and/or a potential for increased biocidal properties to the coated substrates. In particular, this disclosure relates to coating compositions that comprise at least one active compound with two cationic centers, an N-halamine precursor group and a coating-incorporation group.

### BACKGROUND

Microorganisms, such as bacteria, archaea, yeast or fungi, can cause disease, spoilage of inventory, process inefficiencies, disruptions of healthy natural environments and infrastructure degradation. More specifically, healthcare-associated infections (HAIs) are a serious and growing challenge to health care systems around the world. HAIs cause over 100,000 deaths annually and have become the 3rd leading cause of death in Canada. It is estimated that in any given year HAIs directly cost the United States healthcare system between $30B and $45B. Added to that is the increasing prevalence of microorganisms that are resistant to currently available antimicrobial intervention products and processes, including preventative approaches (disinfectants used to control environmental contamination) and reactive approaches (remedies including the use of antibiotics). Therefore, it is necessary to deploy biocidal technologies in various environments as a strategy for controlling unwanted levels or types of microorganisms

A common approach for disinfecting surfaces is the use of liquid disinfectants. Selection of a suitable disinfectant for any given application is dependent upon the environment where the disinfectant will be applied. Selection criteria include the types of micro-organisms targeted, contact time for the disinfectant, level of toxicity tolerable in each application, cleanliness (or lack thereof) of the surface to be cleaned, sensitivity of the substrate to oxidization (i.e., leading to corrosion of the substrate), the presence or absence of biofilms, the amount of organic load present of substrate surfaces, and local regulations that may restrict the use of certain active ingredients within a disinfectant. Some environments are far more challenging to adequately disinfect than others. Note that only one of the preceding factors, which is allowed contact time, is related to the speed of microbial kill.

Biofouling or bio-contamination due to the presence of organic material, also referred to as organic load, is relevant in a wide range of applications and industries, including but not limited to surgical equipment and protective apparel in health-care settings, medical implants and medical devices, biosensors, textiles, food preparation, food packaging, food storage, water purification and/or treatment systems, marine equipment, industrial equipment, equipment in the oil-and-gas industry, agricultural equipment, husbandry-related surfaces and the like The efficiency of disinfectants is reduced in the presence of organic matter due to many different mechanisms for example, protein adsorption. For halogen-based disinfectants, there is a preferential halogenation of protein moieties, such as amines and amides, over the desired killing of micro-organisms. Organic load can also interfere with chemical disinfection of pathogens by forming a physical barrier that interferes with the contact between the disinfectant chemical(s) and the pathogen. Interaction of halogen-based disinfectants, such as N-chloramines, with organic load may lead to the formation of organic chloramines, which are characterized as weakest members of the disinfectants.

### SUMMARY

Embodiments of the present disclosure relate to a compound with the following general formula (Formula 1):

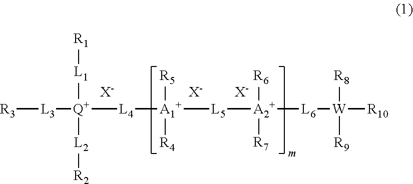

wherein L₁, L₂, L₃, L₄, L₅, and L₆ are independently selected from a group comprising: a chain of the formula C_{b}H_{(2b)} where b is an integer between 0 and 24; triazole, heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline; any combination thereof or nil; wherein at least one of R₁, R₂ and R₃ is an N-halamine precursor that may be selected from a group comprising imidazolidine-2,4-dione (hydantoin); 5,5-dimethylhydantoin; 4,4-dimethyl-2-oxazalidione; tetramethyl-2-imidazolidione; 2,2,5,5-tetramethylimidazo-lidin-4-one; a uracil derivative; and piperidine, including 2,2,6,6-tetramethyl-piperidine, or R₁, R₂ and R₃ are independently selected from H, an alkyl chain of the formula C_{b1}H_{(2b1+1)} where b1 is an integer between 0 and 24, a cyclic organic group including ring structures with at least four carbons and nil; wherein Q⁺, A₁⁺ and A₂⁺ are each a cationic center that is independently selected from the group of N, P, S or nil;
wherein R₄, R₅, R₆ and R₇ are independently selected from an alkyl chain of the formula C_{b2}H₍₂₆₂₊₁₎ where b2 is an integer between 0 and 24 with a further terminal-group of Q⁺; heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline;
wherein if Q⁺ is S, then at least one of L₁, L₂ or L₃ are nil;
wherein if A₁⁺ is S, then at least one of R₄ or R₅ is nil;
wherein if A₂⁺ is S, then at least one of R₆ or R₇ is nil;
wherein X⁻ is a counter ion selected from a group of Cl⁻, Br⁻, I⁻, F⁻, CH3CHOO⁻, ⁻OOCCOO⁻, ⁻OOC(CH2)4COO⁻, CF3COO⁻, BF₄⁻, PF₆⁻, ClO₄⁻, SO₄²⁻, NO₃⁻, OH⁻, CO₃²⁻ PO₄³⁻; or bis(trifluoromethanesulfonyl)amide⁻;
wherein m is an integer selected from 0 to infinity and if m is greater than 2 then between each unit of m each of R₄, R₅, R₆, R₇, A₁⁺, A₂⁺ and L₅ can be the same or different;
wherein W is selected from the group of P⁺, N⁺, S⁺, N, C, Si, O, heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline or another moiety that is capable of bonding with 1, 2, 3 or more further moieties, such further moieties including H, alkyl chains of formula C_{b3}H_{(2b3+1)} where b3 is an integer between 0 and 24, alkene chains of formula C_{b4}H_{(2b4)} where b4 is an integer between 0 and 24, alkyne chains of formula C_{b5}H_{(2b5-2)} where b5 is an integer between 0 and 24, or otherwise;
wherein R₈, R₉ and R₁₀ are each selected from a group comprising: C_{b6}H_{(2z+1)} where b6 is an integer between 0 and 24, phenyl, benzyl, n,n-dimethyl-4-amino-pyridine, vinylbenzyl, C₃H₆NH₂, CH₂CH₂OH, CH₂CH₂CH₂, CH₂C≡CH, CzH_{(2z+1)}R₁₃,

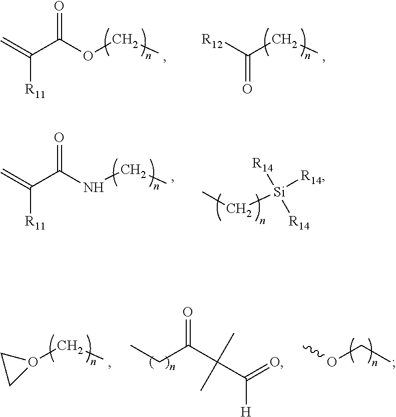

wherein z is an integer selected from 0 to 24;
wherein n is an integer selected from 0 to 24;
wherein R₁₁ is selected from H, CH₃ and CN;
wherein R₁₂ is selected from H, OH, NH₂, O(CH₂)ₚCH₃, alkoxy group of O-alkyl chains of formula CₚH₍₂ₚ₊₁₎ where p is an integer between 0 and 24 and positional isomers of primary, secondary or tertiary alkyl chains;
wherein R₁₃ may be selected from anyone of OH, SH, COOH, CONH₂, OCN, CN, NC, SCN, and NCS
wherein R₁₄ may be selected from anyone of OH, alkoxy group of O-alkyl chains of formula C_{q}H_{(2q+1)} where q is an integer between 0 and 24 and positional isomers of primary, secondary or tertiary alkyl chains;
and
wherein when W is S⁺, at least one of R₈, R₉ and R₁₀ is nil and the other two moieties together with S⁺ may form one of

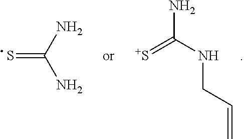

In some embodiments of the present disclosure, the coating-incorporation group (CIG) may be represented by the combination of W and the moieties that bind thereto, as shown in Formula 1.

In some embodiments of the present disclosure, the CIG may be branching group that may branch into an aliphatic alkane, alkene or alkyne-chain that is terminated with one or more functional groups.

In some embodiments of the present disclosure, the compounds of Formula 1 can be included in a coating composition. The coating composition may or may not include a further binding agent.

Some embodiments of the present disclosure relate to the use of coating composition that includes the compounds of Formula 1 for coating a substrate. The substrate may be selected from a group comprising: a textile, a metal or a metal alloy, a polymer, glass, a natural substance, such as wood, or a combination thereof.

Some embodiments of the present disclosure relate to a method of coating a substrate. The method comprises the steps of: wetting at least one surface of the substrate with a coating composition that includes the compounds of Formula 1; drying the coating composition upon the at least one surface of the substrate. Some embodiments of present disclosure further include a step of curing the coating composition at room temperature or with a higher temperature than room temperature. The coated substrate then has biocidal properties or the potential for increased biocidal properties by a further step of exposing the at least one coated surface to one or more halogens.

Some embodiments of the present disclosure relate to a substrate that comprises at least one surface that is coated with a coating that has biocidal activity or the potential for biocidal activity. The at least one surface comprises: at least one or more cationic centers; an N-halamine precursor group; and at least one coating-incorporation group (CIG). The at least one CIG forms a covalent bond with another component within the coating or with a component of the substrate. In some embodiments of the present disclosure, the substrate coating is polymer-based. In some embodiments of the present disclosure, the substrate forms at least part of a surface that is selected from a group of surfaces consisting of: a surgical equipment surface, a surface of protective apparel for use in health-care settings, a surface of a medical implant, a surface of a medical device, a surface of a biosensor, a surface of a textile, a surface used for food preparation, a surface used in food packaging, a surface used in food storage, a surface of a water-purification system, a surface of a water-treatment system, a surface of marine equipment, a surface of industrial equipment, a surface of equipment used in the oil-and-gas industry, a surface of agricultural equipment, a surface used in husbandry or combinations thereof.

### BRIEF DESCRIPTION OF THE DRAWINGS

These and other features of the present disclosure will become more apparent in the following detailed description in which reference is made to the appended drawings.

FIG. 1 is a chart showing an example of data generated by differential scanning calorimetry (DSC) analysis of an example of a coating formulations for a hard substrate, as indicated therein;

FIG. 2 is a chart showing an example of data generated by DSC analysis of an example of a coating formulation for a hard substrate, as indicated therein;

FIG. 3 is a chart showing an example of data generated by DSC analysis of an example of a coating formulation for a hard substrate, as indicated therein; and

FIG. 4 is a chart showing an example of data generated by DSC analysis of an example of a coating formulation for a hard substrate, as indicated therein.

### DETAILED DESCRIPTION

Embodiments of the present disclosure generally relate to one or more compounds that can be included in a coating composition for coating onto a substrate. After coating, the coated substrate may have biocidal activity or the potential for increased biocidal activity. The potential for increased biocidal activity may be realized by exposing the coated substrate to one or more further agents, such as one or more halogens.

Some embodiments of the present disclosure relate to compounds that comprise at least: (i) one or more cationic centers, (ii) an N-halamine precursor group, and (iii) at least one coating-incorporation group (CIG). In some embodiments of the present disclosure the compound may be a monomer that comprises at least (i) one or more cationic centers, (ii) the N-halamine precursor group, and (iii) at least one coating-incorporation group (CIG). The at least one CIG bonds with another component within a coating composition or alternatively, may bond with a component of the substrate. The CIG of the compound may incorporate the monomer into the coating composition, may incorporate the coating composition onto the substrate, or may perform both functions. For example, the CIG may link or cure or tether or polymerize the monomer. The CIG may allow the monomer to be incorporated into a polymer, including incorporation into the polymer backbone, within various different polymers that are synthesized through methods that include, but are not limited to: condensation polymerization; addition polymerization; step-growth polymerization; radical polymerization; chain-growth polymerization; or any combination of these or other polymerization methods through concurrent or subsequent polymer processing or polymerization processes.

In some embodiments of the present disclosure the compound may be incorporated into a thermoplastic-polymer system that may be synthesized through methods such as those described above or others that include additional processing. Additional processing of the thermoplastic-polymer system may include, but is not limited to: extrusion; co-extrusion; molding; thermoforming; calendaring; compounding; thermoforming or other process may be used to coat or integrate the compounds into or onto a base polymer-matrix.

In some embodiments of the present disclosure, the compound may be incorporated into a thermosetting-polymer system or a polymeric precursor thereto that may be processed as described above. Alternatively, processing of the thermoplastic-polymer system and precursors may include, but is not limited to: reaction injection molding, or other forming or coating processes, which may or may not involve an addition of a catalyst or the use of other reactive chemistries.

Some examples of suitable polymerization systems into which the compositions may be incorporated include but are not limited to: textile-coating polymer systems; epoxy-based polymer systems; urethane-based polymer systems; polyurethane-based polymer systems; vinyl-based polymer systems; silicone-based polymer systems; polyethylene-based polymer systems; polybutylene-based polymer systems; poly(buta-1,3-diene)-based polymer systems; polypropylene-based polymer systems, polysulfone-based polymer systems, fluoropolymer based polymer systems, polyvinyl chloride based polymer systems, polyamide based polymer systems, and acrylic-based polymer systems.

Some embodiments of the present disclosure relate to coating compositions that comprise one or more compounds disclosed herein and at least one binding agent. The compound comprises at least: (i) one or more cationic centers, (ii) an N-halamine precursor group, and (iii) at least one CIG. The at least one CIG provides a chemical means that bonds with another component within the coating composition or alternatively, that bonds with a component of a substrate upon which the coating composition may be applied, dried and/or cured. The CIG of the compound incorporates the compound into the coating composition or incorporates the coating composition onto the substrate, or provides both functions. The compound may be covalently bonded to the binding agent, or not. In some examples, the coating composition may further comprise a binding agent that acts as a crosslinking agent.

In some embodiments of the present disclosure, the compounds described herein are protected from inhibition caused by the presence of organic load. Organic load can inhibit or reduce the biocidal activity of the coating composition by various mechanisms. Without being bound by any particular theory, organic load can include a high concentration of protein that interferes with the biocidal activity or the potential for increased biocidal activity of the compounds within the coating composition.

In some embodiments of the present disclosure the CIG may be a terminal functional group that comprises the following functional groups: alcohols; amines, such as primary, secondary and tertiary amines; ethers; epoxide; carbonyl group and derivatives thereof, such as acyl, aldehyde, ketone, carboxylic acid, anhydride, ester and amide; alkyl halides, such as vinyl chloride, vinyl fluoride; vinyl groups and derivatives thereof, such as vinyl acetate and methyl methacrylate; isocyanate group; carboxyl group and an associated carboxylate-ion, thiol, phenol group, imidazole; and ethers.

In some embodiments the CIG may be branching group that may branch into an aliphatic alkane, alkene or alkyne-chain that is terminated with one or more functional groups.

In some examples, the substrate may be selected from a group comprising: a textile, a metal or a metal alloy, a polymer, glass, a natural substance, such as wood, or a combination thereof. The substrate may be natural, synthetic or a combination thereof. When coated with compounds or coating compositions according to the present disclosure, the substrate has biocidal activity or a potential for increased biocidal-activity. In some embodiments, the potential for biocidal activity may be realized by exposing the coated substrate to one or more further agents, such as one or more halogens. In some embodiments of the present disclosure, the coating composition may comprise a compound described herein and at least one binding agent. The compound may comprise at least one N-halamine precursor and at least one quaternary ammonium moiety. The monomer may be covalently bonded to the binding agent, or not. In some examples, the coating composition may further comprise a binding agent that acts as a crosslinking agent.

The coating composition may be coated onto one or more surfaces of a substrate by, for example, a coating process that comprises a step of wetting the substrate surface with a liquid that comprises the coating composition and a drying step to dry the coated substrate. In some examples, the dried coated substrate may then be subjected to a subsequent curing step.

### Definitions

Unless defined otherwise, all technical and scientific terms used herein have the same meaning as commonly understood by one of ordinary skill in the art to which this disclosure belongs.

As used herein, the term “about” refers to an approximately +/−10% variation from a given value. It is to be understood that such a variation is always included in any given value provided herein, whether or not it is specifically referred to.

As used herein, the term “activity” refers to biocidal activity.

As used herein, the term “biocide” means a chemical compound or a chemical composition or a chemical formulation that can kill or render harmless one or more microbes.

As used herein, the term “cationic center” means an atom within a compound that has a positive charge. The positive charge at a cationic center may be balanced by the presence of one or more negatively-charged ionic species, which may also be referred to herein as a counter-ion. Examples of some atoms that form part of cationic centers described here include but are not limited to: nitrogen, phosphorous and sulfur.

As used herein, the terms “microbe”, “microbes”, and “micro-organisms” refer to one or more single-celled or multi-cellular microorganisms such as those exemplified by bacteria, archaea, yeast, and fungi.

As used herein, the terms “N-halamine” and “N-halamine group” are used interchangeably to refer to a compound containing one or more nitrogen-halogen covalent bonds that is normally formed by the halogenation of imide and/or amide and/or amine groups within the compound. The presence of the halogen renders the compound biocidal. N-halamines, as referred to in the present disclosure, include both cyclic and acyclic N-halamine compounds.

As used herein, the terms “N-halamine precursor” and “N-halamine precursor group” are used interchangeably to refer to a functional group of a compound that contains an imide, amide or amine that is susceptible to halogenation to form N-halamines or N-halamine groups with biocidal activity. When part of a compound, N-halamine precursors provide the potential for biocidal activity and/or the potential for increased biocidal-activity. Increased biocidal-activity is as compared to the biocidal activity of the compound independent of the halogenation of the N-halamine precursor group.

The terms “halo” or “halogen” by themselves or as part of another substituent, have the same meaning as commonly understood by one of ordinary skill in the art, and preferably refer to chlorine, bromine, iodine or combinations thereof.

The term “quatemary ammonium cation”, “quatemary ammonium compound”, “quatemary ammonium salt”, “QAC”, “quat” and “QUAT” may be used interchangeably throughout the present disclosure to refer to ammonium compounds in which four organic groups are linked to a nitrogen atom that produces a positively charged ion (cation) of the structure NR₄⁺.

The terms “organic load”, “organic loading”, or “organic soil”, which may be used interchangeably, as used herein, refer to matter composed of organic compounds that have come from the waste products or the remains of living organisms (plant and animal) or organic molecules made by chemical reactions. Organic load is used herein in a context-dependent manner which may vary per facility, but organic load can be generalized into the following non-limiting examples: animal feces; blood; debris; soil; milk; fats; oils; greases; manure; plant residue etc. These examples of organic load are mainly high in proteins, nitrogen, lipids and carbohydrates.

### Example 1: Compounds for Coating Compositions

Some embodiments of the present disclosure relate to at least the following examples of active compounds disclosed herein.

Examples of compounds according to one embodiment of the present disclosure be selected from a group of compounds having following general formula (Formula 1):

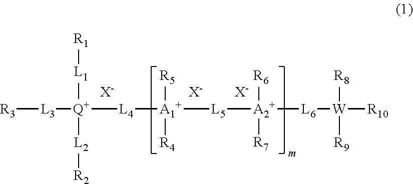

wherein L₁, L₂, L₃, L₄, L₅, and L₆ are independently selected from a group comprising: a chain of the formula C_{b}H_{(2b)} where b is an integer between 0 and 24; triazole, heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline; any combination thereof or nil;
wherein at least one of R₁, R₂ and R₃ is an N-halamine precursor that may be selected from a group comprising imidazolidine-2,4-dione (hydantoin); 5,5-dimethylhydantoin; 4,4-dimethyl-2-oxazalidione; tetramethyl-2-imidazolidione; 2,2,5,5-tetramethylimidazo-lidin-4-one; a uracil derivative; and piperidine, including 2,2,6,6-tetramethyl-piperidine, or R₁, R₂ and R₃ are independently selected from H, an alkyl chain of the formula C_{b1}H_{(2b1+1)} where b1 is an integer between 0 and 24, a cyclic organic group including ring structures with at least four carbons and nil;
wherein Q⁺, A₁⁺ and A₂⁺ are each a cationic center that is independently selected from the group of N, P, S or nil;
wherein R₄, R₅, R₆ and R₇ are independently selected from an alkyl chain of the formula C_{b2}H_{(2b2+1)} where b2 is an integer between 0 and 24 with a further terminal-group of Q⁺; heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline;
wherein if Q⁺ is S, then at least one of L₁, L₂ or L₃ are nil;
wherein if A₁⁺ is S, then at least one of R₄ or R₅ is nil;
wherein if A₂⁺ is S, then at least one of R₆ or R₇ is nil;
wherein X⁻ is a counter ion selected from a group of Cl⁻, Br⁻, I⁻, F⁻, CH₃CHOO⁻, ⁻OOCCOO⁻, ⁻OOC(CH₂)4COO⁻, CF3COO⁻, BF₄⁻, PF₆⁻, ClO₄⁻, SO₄²⁻, NO₃⁻, OH⁻, CO₃²⁻ PO₄³⁻; or bis(trifluoromethanesulfonyl)amide⁻;
wherein m is an integer selected from 0 to infinity and if m is greater than 2 then between each unit of m each of R₄, R₅, R₆, R₇, A₁⁺, A₂⁺ and L₅ can be the same or different;
wherein W is selected from the group of P⁺, N⁺, S⁺, N, C, Si, O, heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline or another moiety that is capable of bonding with 1, 2, 3 or more further moieties, such further moieties including H, alkyl chains of formula C_{b3}H_{(2b3+1)} where b3 is an integer between 0 and 24, alkene chains of formula C_{b4}H_{(2b4)} where b4 is an integer between 0 and 24, alkyne chains of formula C_{b5}H_{(2b5-2)} where b5 is an integer between 0 and 24, or otherwise;
wherein R₈, R₉ and R₁₀ are each selected from a group comprising: C_{b6}H_{(2b6)} where b6 is an integer between 0 and 24, phenyl, benzyl, n,n-dimethyl-4-amino-pyridine, vinylbenzyl, C₃H₆NH₂, CH₂CH₂OH, CH₂CH₂—CH₂, CH₂C≡CH, CzH_{(2z+1)}R₁₃,

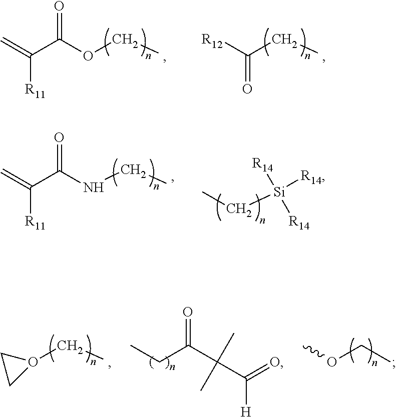

wherein z is an integer selected from 0 to 24;
wherein n is an integer selected from 0 to 24;
wherein R₁₁ is selected from H, CH₃ and CN;
wherein R₁₂ is selected from H, OH, NH₂, O(CH₂)ₚCH₃, alkoxy group of O-alkyl chains of formula CₚH₍₂ₚ₊₁₎ where p is an integer between 0 and 24 and positional isomers of primary, secondary or tertiary alkyl chains;
wherein R₁₃ may be selected from anyone of OH, SH, COOH, CONH₂, OCN, CN, NC, SCN, and NCS
wherein R₁₄ may be selected from anyone of OH, alkoxy group of O-alkyl chains of formula C_{q}H_{(2q+1)} where q is an integer between 0 and 24 and positional isomers of primary, secondary or tertiary alkyl chains;
and
wherein when W is S⁺, at least one of R₈, R₉ and R₁₀ is nil and the other two moieties together with S⁺ may form one of

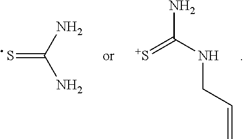

One example of a compound according to one embodiment of the present disclosure is referred to herein as DEPA or D2 with the following general formula (Formula 2):

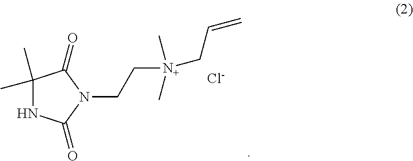

Another example of a compound according to an embodiment of the present disclosure is referred to herein as PIP—C6-C2-OH or PO and it has the following general formula (Formula 3):

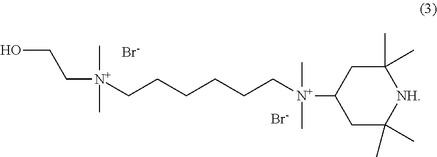

Another example of a compound according to an embodiment of the present disclosure is referred to herein as PIP—C3-C2-OH or PO3 and it has the following general formula (Formula 4):

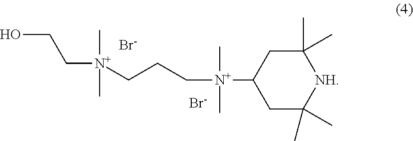

Another example of a compound according to an embodiment of the present disclosure is referred to herein as PIP—C4-PPh-C4-PPh-C3-OH or PH and it has the following general formula (Formula 5):

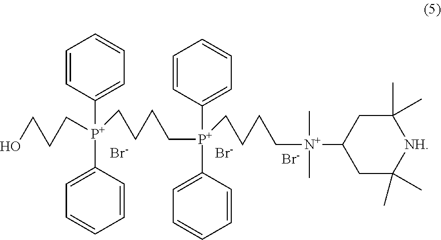

Another example of a compound according to an embodiment of the present disclosure is referred to herein as HYD-C2-C, 1-vinyl-phosphate or DEPA phosphate or DP and it has the following general formula (Formula 6):

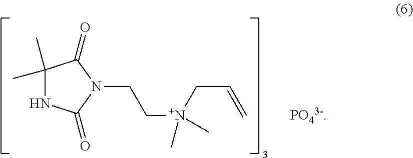

Another example of a compound according to an embodiment of the present disclosure is referred to herein as PIP—C4-vinyl or PV and it has the following general formula (Formula 7):

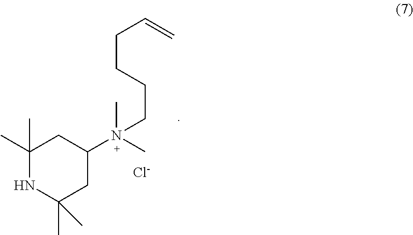

Another example of a compound according to an embodiment of the present disclosure is referred to herein as PIP—C4-C2-vinyl-acetate or VA and it has the following general formula (Formula 8):

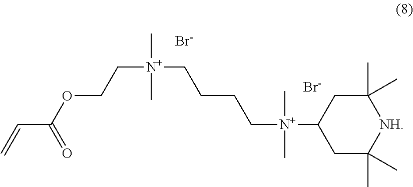

Another example of a compound according to an embodiment of the present disclosure is referred to herein as PIP—C4-C2-vinyl-acetate-phosphate or V2 and it has the following general formula (Formula 8A):

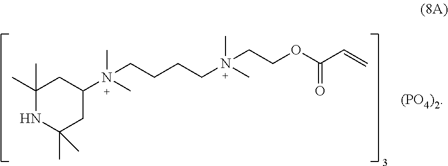

Another example of a compound according to an embodiment of the present disclosure is referred to herein as PIP—C4-PPh-C4-PPh-benzyl-vinyl or B1 and it has the following general formula (Formula 8B):

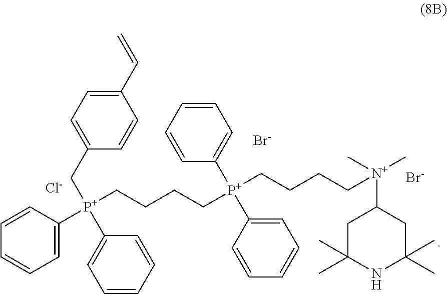

Another example of a compound according to an embodiment of the present disclosure is referred to herein as PIP—C8-C2-VA or V3 and it has the following general formula (Formula 8C):

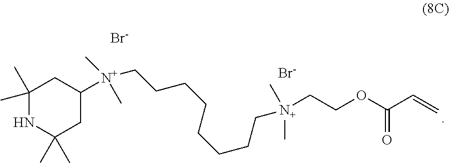

Another example of a compound according to an embodiment of the present disclosure has the following general formula (Formula 8D):

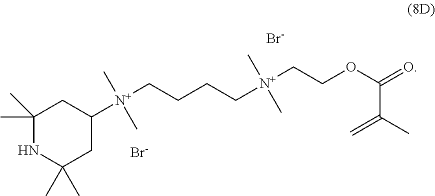

Another example of a compound according to an embodiment of the present disclosure has the following general formula (Formula 8E):

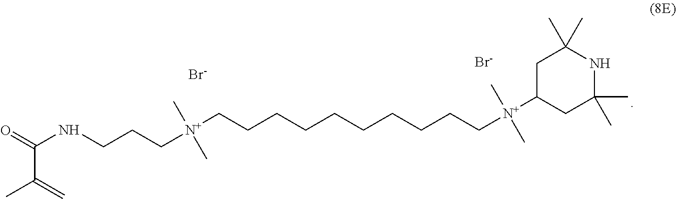

Another example of a compound according to an embodiment of the present disclosure has the following general formula (Formula 8F):

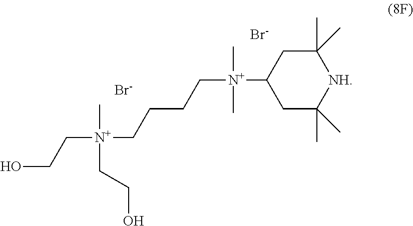

Another example of a compound according to an embodiment of the present disclosure has the following general formula (Formula 8G):

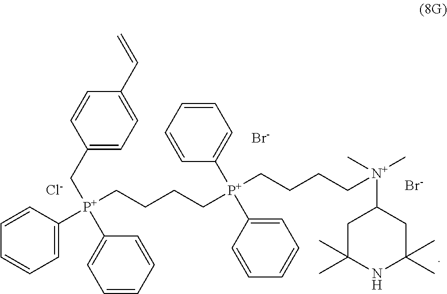

Another example of a compound according to an embodiment of the present disclosure has the following general formula (Formula 8H):

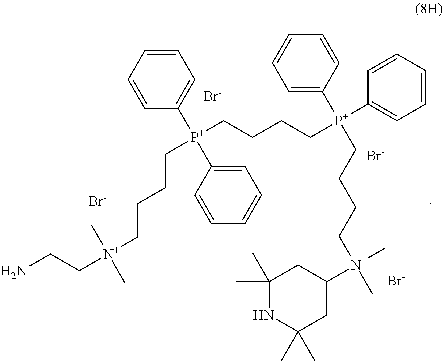

Another example of a compound according to an embodiment of the present disclosure has the following general formula (Formula 8I):

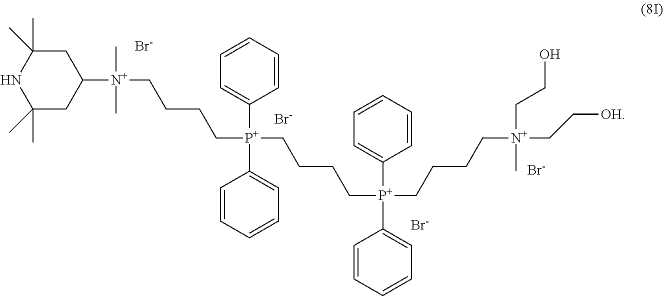

Another example of a compound according to an embodiment of the present disclosure has the following general formula (Formula 8J):

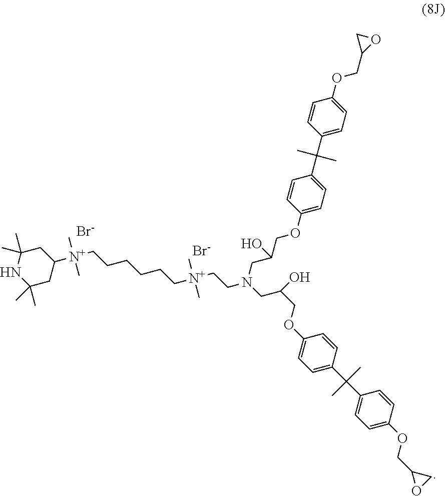

Another example of a compound according to an embodiment of the present disclosure has the following general formula (Formula 8K):

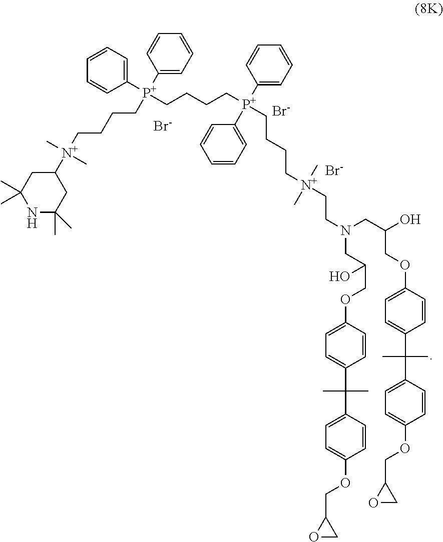

### Example 2: Coating Compositions for Textile Substrates

Some embodiments of the present disclosure relate to at least the following examples of coating compositions that comprise one or more of the compounds described above.

Table 1 below summarizes the nomenclature used to describe the formulations of the coating compositions described further below.

TABLE 1
A summary of the coating composition nomenclature.

| Component | |
|---|---|
| Name | Description |
| TRIBUILD DX-164 | A water-based emulsion that comprises |
| | a homopolymer of polyvinyl acetate. |
| TRICOMEL 100 | A water soluble, modified melamine crosslinker. |
| Permafresh 600 | A fabric softener polymer. |
| Catalyst 531 | An activated water-based catalyst solution for rapid |
| | curing. |

Matrix

| | |
|---|---|
| F2 | Tribuild DX-164 and TRICOMEL 100 |
| F14 | Permafresh 600 (polymer) and Catalyst 531 |
| | (crosslinker/curing agent) |

Active Compounds

| | |
|---|---|
| D2 | DEPA 2 (Formula 2) |
| PO | PIP-C6-C2-OH (Formula 3) |
| PO3 | PIP-C3-C2-OH (Formula 4) |
| PH | PIP-C4-PPh-C4-PPh-C3-OH (Formula 5) |
| DP | HYD-C2-C1-vinyl-phosphate (Formula 6) |
| PV | PIP-C4-vinyl (Formula 7) |
| VA | PIP-C4-C2-vinyl-acetate (Formula 8) |
| V2 | PIP-C4-C2-vinyl-acetate phosphate (Formula 8A) |
| B1 | PIP-C4-PPh-C4-PPh-benzyl-vinyl (Formula 8B) |
| V3 | PIP-C8-C2-vinyl-acetate (Formula 8C) |

Substrate

| | |
|---|---|
| 7409WOB | 7409WOB - polycotton 65/35 |

One example of a coating-composition according to an embodiment of the present disclosure, referred to herein as the first coating-composition, comprises four components within a formulation which is summarized in Table 2 below.

TABLE 2
A summary of a formulation of the first coating-composition.

| First Coating-Composition | Mass (g) | % (wt/wt) |
|---|---|---|
| D2 (Formula 2) | 0.9 | 0.93 |
| H₂O | 79.30 | 81.58 |
| TRIBUILD DX-164 (48% solids) | 10.00 | 10.29 |
| TRICOMEL 100 (41% solids) | 7.00 | 7.20 |
| Totals | 97.2 | 100 |

A second example of a coating composition according to an embodiment of the present disclosure may comprise four components within a formulation as summarized in Table 3 below.

TABLE 3
A summary of the formulation of the second coating-composition.

| Second Coating-Composition | Mass (g) | % (wt/wt) |
|---|---|---|
| PIP-C6-C2-OH (Formula 3) | 1.44 | 1.44 |
| H₂O | 90.59 | 90.59 |
| Permafresh 600 | 5.48 | 5.48 |
| Catalyst 531 | 2.49 | 2.49 |
| Totals | 100 | 100 |

A third example of a coating-composition according to an embodiment of the present disclosure may comprise four components within a formulation as summarized in Table 4 below.

TABLE 4
A summary of the formulation of the third coating-composition.

| Third Coating-Composition | Mass (g) | % (wt/wt) |
|---|---|---|
| PIP-C3-C2-OH (Formula 4) | 1.33 | 1.33 |
| H₂O | 90.59 | 90.68 |
| Permafresh 600 | 5.48 | 5.49 |
| Catalyst 531 | 2.49 | 2.49 |
| Totals | 99.89 | 100 |

A fourth example of a coating-composition according to an embodiment of the present disclosure may comprise four components within a formulation as summarized in Table 5 below.

TABLE 5
A summary of the formulation of the fourth coating-composition.

| Fourth Coating-Composition | Mass (g) | % (wt/wt) |
|---|---|---|
| PIP-C4-PPh-C4-PPh-C3-OH (Formula 5) | 2.27 | 2.27 |
| H₂O | 89.83 | 89.83 |
| Permafresh 600 | 5.43 | 5.43 |
| Catalyst 531 | 2.47 | 2.47 |
| Totals | 100 | 100 |

A fifth example of a coating-composition according to an embodiment of the present disclosure may comprise four components within a formulation as summarized in Table 6 below.

TABLE 6
A summary of the formulation of the fifth coating-composition.

| Fifth Coating-Composition | Mass (g) | % (wt/wt) |
|---|---|---|
| DEPA phosphate (Formula 6) | 0.90 | 0.93 |
| H₂O | 79.30 | 81.53 |
| TRIBUILD DX-164 (48% solids) | 10.00 | 10.29 |
| TRICOMEL 100 (41% solids) | 7.00 | 7.20 |
| Totals | 97 | 100 |

A sixth example of a coating-composition according to an embodiment of the present disclosure may comprise four components within a formulation as summarized in Table 7 below.

TABLE 7
A summary of the formulation of the sixth coating-composition.

| Sixth Coating-Composition | Mass (g) | % (wt/wt) |
|---|---|---|
| PIP-C4-vinyl (Formula 7) | 0.85 | 0.87 |
| H₂O | 79.30 | 81.63 |
| TRIBUILD DX-164 (48% solids) | 10.00 | 10.29 |
| TRICOMEL 100 (41% solids) | 7.00 | 7.21 |
| Totals | 97 | 100 |

A seventh example of a coating-composition according to an embodiment of the present disclosure comprise four components within a formulation as summarized in Table 8 below.

TABLE 8
A summary of the formulation of the seventh coating-composition.

| Seventh Coating-Composition | Mass (g) | % (wt/wt) |
|---|---|---|
| PIP-C4-C2-vinyl-acetate (Formula 8) | 0.53 | 0.55 |
| H₂O | 79.30 | 81.90 |
| TRIBUILD DX-164 (48% solids) | 10.00 | 10.33 |
| TRICOMEL 100 (41% solids) | 7.00 | 7.23 |
| Totals | 97 | 100 |

An eighth example of a coating-composition according to an embodiment of the present disclosure may comprise four components with a formulation summarized in Table 8A below.

TABLE 8A
A summary of the formulation of the 8A coating-composition.

| 8A Coating-Composition | Mass (g) | % (wt/wt) |
|---|---|---|
| PIP-C4-C2-vinyl-acetate-phosphate | 1.40 | 1.43 |
| H₂O | 79.30 | 81.17 |
| TRIBUILD DX-164 (PVAc) | 10.00 | 10.24 |
| TRICOMEL 100 | 7.00 | 7.16 |
| Totals | 98 | 100 |

A ninth example of a coating-composition according to an embodiment of the present disclosure may comprise four components with a formulation summarized in Table 8B below.

TABLE 8B
A summary of the formulation of the 8B coating-composition.

| 8B Coating-Composition | Mass (g) | % (wt/wt) |
|---|---|---|
| PIP-C4-PPh-C4-PPh-benzyl-vinyl | 2.78 | 2.81 |
| Methanol | 5.00 | 5.04 |
| H₂O | 74.40 | 75.01 |
| TRIBUILD DX-164 (PVAc) | 10.00 | 10.08 |
| TRICOMEL | 7.00 | 7.06 |
| Totals | 99 | 100 |

A tenth example of a present coating-composition according to an embodiment of the present disclosure may comprise four components with a formulation summarized in Table 8C below.

TABLE 8C
A summary of the formulation of the 8C coating-composition.

| 8C Coating-Composition | Mass (g) | % (wt/wt) |
|---|---|---|
| PIP-C8-C2-VA | 1.63 | 1.64 |
| Methanol | 0.00 | 0.00 |
| H₂O | 79.40 | 80.05 |
| TRIBUILD DX-164 (PVAc) | 10.00 | 10.08 |
| TRICOMEL 100 | 7.00 | 7.06 |
| Totals | 98 | 99 |

An eleventh example of a present coating-composition according to an embodiment of the present disclosure that comprises the compound with Formula 8J that was cured using a commercially available diamine crosslinker. FIG. 5 shows an example of a reaction scheme used to make the compound with the Formula 8J.

Embodiments of the present disclosure that relate to coating compositions and formulations thereof are not limited to the formulas of coating compositions provided above.

The formulations of these coating compositions were made according to the following general methodology.

The compound that is to be applied in a coating formulation was dissolved in water and mixed until the active-compound liquid was substantially clear and without any particles that were visible to the eye. If preparing a formulation with the F2 matrix, the TRIBUILD DX-164 was added first to the active-compound liquid while mixing to best ensure a homogenous solution. Next the TRICOMEL 100 was added during mixing. If preparing a formulation with the F14 matrix, the Permfresh 600 was added first and the Catalyst 531 second, both were added while mixing.

### Example 3: Coating Process for Textile Substrates

Next the padded roller applicators were cleaned with distilled water (however, a wire sponge pad and ethanol may also be used if required). The padded roller applicator used was a vertical padder applicator that permitted a controlled roller-pad speed and a pad pressure between opposing roller pads. For the data presented below, the roller pad speed was set at 0.5 m/min and a pad pressure of 5 of an arbitrary scale where 10 is the highest pad pressure and 1 is the lowest.

About 50 g of the coating composition were added on to the padded rollers and the substrate was placed into the rollers without any slack. The substrate was run once through the padded rollers. The wet substrate was then weighed. The wet fabric was then stretched and placed in an oven for a drying step at about 105° C. for two minutes. Next was a curing step at about 140° C. for about two minutes. The substrate was then coated with a cured coating-formula and it was considered a coated substrate. The coated substrate was weighed and the hand of the fabric was determined.

Tables 9A and 9B provide examples of physical data that were collected during the coating process.

TABLE 9A
Examples of physical data collected during the coating process with each of
the first, second, third and fourth coating compositions.

| Coating | | Wet Pick-Up | | | | | Dry Pick-Up | | | | |
|---|---|---|---|---|---|---|---|---|---|---|---|
| Composition | Mass, | Mass, | Pick-up, | Pick-up, | Formulated | Mass, Pick-up | Mass, | Pick-up, | Pick-up, | Compound | Compound |
| Used | init. (g) | wet (g) | wet (%) | wet (g) | compound | compound (g) | cured (g) | dry (%) | dry (g) | per coating | per fabric |
| 2nd | 9.55 | 17.68 | 85.06% | 8.13 | 0.9% | 0.07 | 10.03 | 5.0% | 0.48 | 15.30% | 0.77% |
| 3rd | 9.45 | 17.45 | 84.71% | 8.00 | 0.9% | 0.07 | 9.89 | 4.6% | 0.44 | 16.44% | 0.76% |
| 4th | 9.53 | 17.35 | 82.15% | 7.83 | 0.9% | 0.07 | 10.00 | 5.0% | 0.47 | 14.86% | 0.74% |
| 1st | 9.44 | 17.65 | 86.98% | 8.21 | 0.9% | 0.07 | 9.89 | 4.8% | 0.45 | 16.31% | 0.78% |
| 1st | 9.66 | 18.00 | 86.34% | 8.34 | 0.9% | 0.08 | 10.02 | 3.8% | 0.36 | 20.66% | 0.78% |

TABLE 9B
Examples of physical data collected during the coating process with each of
the first, second, fifth, sixth, and seventh coating compositions.

| Coating | | Wet Pick-Up | | | | | Dry Pick-Up | | | | |
|---|---|---|---|---|---|---|---|---|---|---|---|
| Composition | Mass, | Mass, | Pick-up, | Pick-up, | Formulated | Mass, Pick-up | Mass, | Pick-up, | Pick-up, | Compound | Compound |
| Used | init. (g) | wet (g) | wet (%) | wet (g) | compound | compound (g) | cured (g) | dry (%) | dry (g) | per coating | per fabric |
| 2nd | 9.55 | 17.68 | 85.06% | 8.13 | 0.9% | 0.07 | 10.03 | 5.0% | 0.48 | 15.30% | 0.77% |
| 3rd | 9.45 | 17.45 | 84.71% | 8.00 | 0.9% | 0.07 | 9.89 | 4.6% | 0.44 | 16.44% | 0.76% |
| 4th | 9.53 | 17.35 | 82.15% | 7.83 | 0.9% | 0.07 | 10.00 | 5.0% | 0.47 | 14.86% | 0.74% |
| 1st | 9.44 | 17.65 | 86.98% | 8.21 | 0.9% | 0.07 | 9.89 | 4.8% | 0.45 | 16.31% | 0.78% |
| 1st | 9.66 | 18.00 | 86.34% | 8.34 | 0.9% | 0.08 | 10.02 | 3.8% | 0.36 | 20.66% | 0.78% |

### Example 4: Data Collected from Coated Textile-Substrates

The coated substrates were subjected to a halogenation step by exposure to chlorine. The amount of chlorine that loaded on to each coated substrate was then evaluated using iodometric titration. Briefly, to chlorinate the samples 50 mL of ultrapure water was added to a 250 mL Erlenmeyer flask. A Bleach solution of 72678 ppm of chlorine was then added to the flask to achieve the desired chlorination solution concentration (68.79 μL to achieve 100 ppm, and up to 1031 μL to achieve up to 1500 ppm). After stirring the bleach into the solution, the fabric samples were added, secured in a shaker and then agitated for up to 1 hour. After the hour of shaking, the solution was drained from the flask and the sample was washed 4 times with distilled water to remove any excess chlorine. Samples were then set out for an hour in open air to dry.

The concentration of active chlorine on the fabric samples was analyzed by a traditional iodometric titration method. Briefly, each 1×1 inch sample was immersed in a solution of 30 mL of distilled water and 25 mL of a 0.001 N sodium thiosulfate standard solution. After stirring in a 100 mL beaker with a magnetic stir rod for one hour 2 mL of 5% acetic acid buffer solution was added. Then, with continued stirring, the solution was titrated with 0.001 N iodine standard solution by monitoring millivolt changes with a redox electrode (platinum Ag/AgCl). The active chlorine concentration of the samples was then calculated from the following equation:

[Cl+](ppm)=35.45×(V1−V2)×N=1000/(2×Area)

where V1 and V2 are the volumes (mL) of the iodine solution consumed in titrations of blank sodium thiosulfate solution and that with PET sample in, respectively; N is the normality of iodine solution; and W is the weight of the samples in grams. This process was done for each sample tested to determine the active chlorine concentrations resulting from the chlorination exposure.

Tables 10, 11 and 12 provide examples of chlorine (ppm) that loaded onto coated substrates.

TABLE 10
Amount of chlorine (ppm) loaded onto coated substrates when exposed to
100 ppm of chlorine and shaken for 5 minutes.

| | Active | |
|---|---|---|
| | Chlorine | Standard |
| Coating Formulation Used | (PPM) | Deviation |
| 2nd | 82 | 14 |
| 3rd | 95 | 13 |
| 4th | 167 | 49 |
| 1st | 296 | 33 |

TABLE 11
Amount of chlorine (ppm) loaded on to coated substrates when exposed to
100 ppm of chlorine and shaken for 5 minutes.

| | Active | |
|---|---|---|
| | Chlorine | Standard |
| Coating Formulation Used | (PPM) | Deviation |
| 5th | 78 | 17 |
| 6th | 84 | 5 |
| 1st | 189 | 10 |
| 7th | 266 | 9 |
| 2nd | 36 | 21 |

TABLE 12
Amount of chlorine (ppm) loaded onto coated substrates when exposed to
100 ppm of chlorine and shaken for 60 minutes.

| | Active | |
|---|---|---|
| | Chlorine | Standard |
| Coating Formulation Used | (PPM) | Deviation |
| 5th | 234 | 30 |
| 6th | 206 | 18 |
| 1st | 223 | 15 |
| 7th | 451 | 17 |
| 2nd | 30 | 15 |

In order to demonstrate the durability of the coated substrates, the coated substrates referred to in Table 12 were then subjected to a simulated 50-wash cycle in a laundrameter. The coated substrate that was coated with the first coating formulation, was not included. Chlorine loading was then evaluated, Table 13 provides examples of this data.

TABLE 13
Amount of chlorine (ppm) loaded onto coated substrates
when exposed to 100 ppm of chlorine, shaken for
60 minutes and then subjected to simulated 50 wash cycles.

| | Active | |
|---|---|---|
| | Chlorine | Standard |
| Coating Formulation Used | (PPM) | Deviation |
| 5th | 239 | 18 |
| 6th | 306 | 22 |
| 7th | 313 | 11 |
| 2nd | 127 | 17 |

The charge density was also assessed for the textile substrate that was coated with the 8B coating-composition. The results of this assessment was that there was a charge density of 6.02E+15 (N+/cm²) with a standard deviation of 5.61E+14.

The biocidal activity of the coated substrates was assessed using the AATCC 100 antimicrobial textile testing protocol with minor modifications to ensure good contact.

Reference is made herein to tryptic soya broth (TSB), Mueller Hinton broth (MH broth) and fetal bovine serum (FBS). These compounds were used to impart an organic load on the coated substrates. A challenge with 100% TSB is equivalent to about a 3.0% organic-load challenge. A challenge with 100% MH broth is equivalent to about a 2.1% organic-load challenge. A challenge with FBS may be equivalent to the volumetric amount of FBS added to the challenging inoculum, for example, a challenge with 5% FBS is equivalent to about a 5% organic-load challenge. Tables 14, 15 and 16 summarize the constituents of these compounds.

TABLE 14
Constituents of TSB.
TSB

| | Concentration |
|---|---|
| Constituent | g/— |
| Casein peptone | 17 |
| Dipotassium hydrogen phosphate | 2.5 |
| Glucose | 2.5 |
| Papain digest | 3 |
| Sodium chloride | 5 |

TABLE 15
Constituents of MH broth.
Mueller Hinton(MH) Broth

| | Concentration |
|---|---|
| Constituent | g/L |
| Beef infusion solids | 2 |
| Casein hydrolysate | 17.5 |
| Starch | 1.5 |

TABLE 16
Constituents of FBS.
Fetal Bovine Serum

| Component | Average | Range |
|---|---|---|
| Endotxins (ng ml) | 0.35 | 0.01-10.0 |
| Glucose (mg ml) | 1.25 | 0.85-1.81 |
| Protein (mg ml) | 38 | 32-70 |
| Albumin (mg ml) | 23 | 20-36 |
| Hemoglobine (μg ml) | 113 | 24-181 |
| Bilirubin total (μg ml) | 1 | 3-11 |
| Bilirubin direct (μg ml) | 2 | 0-5 |
| Cres (μg ml) | 160 | 140-200 |
| Lrate (μg ml) | 29 | 13-41 |
| Creatinin (μg ml) | 31 | 76-13 |
| Insulin (μg ml) | 10 | 6-14 |
| Cortisol (mg ml) | 0.5 | 0.1-23 |
| Growth hormone (ng ml) | 39.0 | 18.7-51.6 |
| Parachormone, PTH (ng ml) | 1.72 | 0.085-6.15 |
| [symbol] doll Vitamine, 13 (ng ml) | 1.2 | 0.50-2.23 |
| Thyroxine TI (ng ml) | 0.12 | 0.08-0.16 |
| Thyroid-stimulating hormone, LSH (ng ml) | 1.22 | 0.2-4.5 |
| Follicle-stimulating hormone, FSH (ng ml) | 95 | 20-335 |
| lestosterone (pg ml) | 400 | 210-990 |
| Progesterone, P4 (pg ml) | 80 | 3-360 |
| Pinlactin [symbol] I.TII (pg ml) | 1.6 | 20-500 |
| Luteinizing hermone, LH [symbol] (pg ml) | 8 | 12-18 |
| Prostaglandin E (ng ml) | 59 | 0.5-30.5 |
| Prostaglandin F (ng ml) | 12.3 | 3.8-22.6 |
| Vitamine A (ng ml) | 90 | 10-450 |
| Vitamine F (ng ml) | 1.1 | 1-42 |
| Cholesterol (μg ml) | 310 | 120-630 |
| Lactate-dehydrogenase LDII (ml:ml) | 864 | 260-1.215 |
| Alkaline Phosphatase (ml:ml) | 255 | 110-352 |
| Aspartate Aminotransferase ASAT (ml:ml) | 130 | 20-200 |
| Sodium Na (μeq ml) | 137 | 125-143 |
| Potassium K (μeq ml) | 11.2 | 10.0-14.0 |
| Calcium Ca [symbol] (μeq ml) | 6.75 | 6.30-7.15 |
| Chloride CT (μeq ml) | 103 | 98-108 |
| Phosphate P (μg ml) | 98 | 43-114 |
| Selea (μg ml) | 0.026 | 0.014-0.038 |
| pH | 7.40 | 7.20-7.60 |

[symbol]

indicates data missing or illegible when filed

Table 17 provides a summary the biocidal activity of the first, second, third and fourth coating compositions when coated onto a substrate, then chlorinated at 100 ppm for 60 minutes, and then challenged with 5% TSB. Unchlorinated substrate data are provided for reference. The test bacterium used was a Gram-positive CA-MRSA 40065.

TABLE 17
Summary of biocidal activity of first, second, third and fourth coating
compositions with 5% TSB.

| | | Coating Formulation | Log₁₀ | Log₁₀ | Log₁₀ | Log₁₀ | Log₁₀ |
|---|---|---|---|---|---|---|---|
| Bacteria | | Used | 0 | 10 | 20 | 30 | 60 |
| | | | Bacteria Reduction at various contact times (min) | | | | |
| Gram-Positive | CA-MRSA | 2nd | / | 1.08 | 1.38 | 1.55 | 1.27 |
| | 40065 | 3rd | / | 1.05 | 1.14 | 1.35 | 1.18 |
| | | 4th | / | 2.65 | 2.71 | 2.77 | 6.55 |
| | | 1st | / | 0.45 | 0.73 | 1.36 | 2.95 |
| | | | Bacteria Reduction at various contact times (Hrs) | | | | |
| | | Unchlorinated Samples⁽¹⁾ | 1 | 5 | / | / | / |
| | | 2nd | 0.86 | 6.55 | / | / | / |
| | | 3rd | 0.88 | 3.15 | / | / | / |
| | | 4th | 3.07 | 6.55 | / | / | / |
| | | 1st | 0.82 | 6.55 | / | / | / |

General Note:
⁽¹⁾Unclorinated samples were kept in 37° C. incubator with ~70% humidity for 24 hours
⁽²⁾5% TSB was added to all samples
⁽³⁾All Samples Chlorinated at 100 PPM for 1 hour

Table 18 provides a summary the biocidal activity of the first, second, third and fourth coating compositions when coated onto a substrate, then chlorinated at 100 ppm for 60 minutes, and then challenged with 5% FBS. Unchlorinated and substrate data are provided for reference. The test bacterium was a Gram-positive CA-MRSA 40065.

TABLE 18
Summary of biocidal activity of first, second, third and fourth coating
compositions with 5% TSB.

| | | Coating Formulation | Log₁₀ | Log₁₀ | Log₁₀ | Log₁₀ | Log₁₀ | Log₁₀ |
|---|---|---|---|---|---|---|---|---|
| Bacteria | | Used | 0 | 5 | 10 | 20 | 30 | 60 |
| | | | Bacteria Reduction at various contact times (min) | | | | | |
| Gram-Positive | CA-MRSA | 2nd | / | 0.30 | 0.35 | 0.36 | 0.30 | 0.38 |
| | 40065 | 3rd | / | 0.21 | 0.34 | 0.36 | 0.32 | 0.38 |
| | | 4th | / | 2.57 | 2.03 | 3.05 | 3.22 | 6.22 |
| | | 1st | / | 0.18 | 0.33 | 1.48 | 6.22 | 6.22 |
| | | | Bacteria Reduction at various contact times (Hrs) | | | | | |
| | | Unchlorinated Samples⁽¹⁾ | 1 | 5 | / | / | / | / |
| | | 2nd | 0.31 | 1.48 | / | / | / | / |
| | | 3rd | 0.34 | 1.30 | / | / | / | / |
| | | 4th | 2.48 | 5.29 | / | / | / | / |
| | | 1st | 0.39 | 2.15 | / | / | / | / |

General Note:
⁽¹⁾Unclorinated samples were kept in 37° C. incubator with ~70% humidity for 24 hours
⁽²⁾5% FBS was added to all samples
⁽³⁾All Samples Chlorinated at 100 PPM for 1 hour

Table 19 provides a summary the biocidal activity of the fifth, sixth, seventh and first coating compositions when coated on a substrate, chlorinated at 100 ppm for 60 minutes and then challenged with 5% TSB. Unchlorinated substrate and virgin substrate (uncoated) data are provided for reference. The test bacterium used was a Gram positive CA-MRSA 40065.

TABLE 19
Summary of biocidal activity of fifth, sixth, seventh and first coating
compositions with 5% TSB.

| | | Coating Composition | Log₁₀ | Log₁₀ | Log₁₀ | Log₁₀ | Log₁₀ | Log₁₀ |
|---|---|---|---|---|---|---|---|---|
| Bacteria | | Used | 0 | 10 | 20 | 30 | 60 | 90 |
| | | | Bacteria Reduction at various contact times (min) | | | | | |
| Gram-Positive | CA-MRSA | 5th | / | −0.08 | 0.25 | 0.23 | 0.15 | 1.11 |
| | 40065 | 6th | / | −0.23 | −0.43 | −0.18 | 0.87 | 6.47 |
| | | 1st | / | −0.20 | −0.32 | −0.11 | 0.76 | 6.47 |
| | | 7th | / | −0.11 | 0.34 | 0.21 | 1.25 | 6.47 |
| | | | Bacteria Reduction at various contact times (Hrs) | | | | | |
| | | Unchlorinated Samples | 1 | 5 | / | / | / | / |
| | | Virgin Substrate | 0.11 | 0.45 | / | / | / | / |
| | | 5th | 0.1 | 1.67 | / | / | / | / |
| | | 6th | 0 | 6.47 | / | / | / | / |
| | | 1st | −0.22 | 2.00 | / | / | / | / |
| | | 7th | −0.02 | 3.16 | / | / | / | / |

General Note:
⁽¹⁾5% Tryptone Soya Broth on all samples
⁽²⁾.01% v/v% wetting agent Triton X-100 was added to all samples

Table 20 provides a summary the biocidal activity of the fifth, sixth, seventh and first coating compositions when coated on a substrate, then chlorinated at 100 ppm for 60 minutes in phosphate buffered saline (PBS). Unchlorinated substrate and virgin substrate (uncoated) data are provided for reference. The test bacterium was a Gram-positive CA-MRSA 40065.

TABLE 20
Summary of biocidal activity of fifth, sixth, seventh and first coating
compositions in phosphate buffered saline.

| | | Coating Formulation | Log₁₀ | Log₁₀ | Log₁₀ | Log₁₀ | Log₁₀ | Log₁₀ |
|---|---|---|---|---|---|---|---|---|
| Bacteria | | Used | 0 | 10 | 20 | 30 | 60 | 90 |
| | | | Bacteria Reduction at various contact times (min) | | | | | |
| Gram-Positive | CA-MRSA | 5th | / | 0.14 | 1.85 | 2.49 | 6.18 | 6.18 |
| | 40065 | 6th | / | −0.18 | −0.13 | 2.44 | 6.18 | 6.18 |
| | | 1st | / | 0.04 | 0.65 | 1.41 | 6.18 | 6.18 |
| | | 7th | / | −0.08 | 0.71 | 2.16 | 6.18 | 6.18 |
| | | | Bacteria Reduction at various contact times (Hrs) | | | | | |
| | | Unchlorinated Samples | 1 | 5 | / | / | / | / |
| | | Virgin Substrate | −0.29 | 0.09 | / | / | / | / |
| | | 5th | −0.28 | 0.19 | / | / | / | / |
| | | 6th | −0.16 | 0.28 | / | / | / | / |
| | | 1st | −0.07 | 0.23 | / | / | / | / |
| | | 7th | −0.14 | 0.18 | / | / | / | / |

General Note:
⁽¹⁾.01% v/v% wetting agent Triton X-100 was added to all samples
⁽²⁾Several cell colonies for F2PVP1-1 and F2D2P1-1 at 60 min and 90 min were detected and considered as O. Reference USP 34, United States Pharmacopeia pp. 783-786, 2011.

Table 21 provides a summary the biocidal activity of the fifth, sixth, seventh and first coating compositions when coated on a substrate, then chlorinated at 100 ppm for 60 minutes, and then challenged with 5% FBS. Unchlorinated substrate data are provided for reference. The test bacterium was a Gram-positive CA-MRSA 40065.

TABLE 21
Summary of biocidal activity of fifth, sixth, seventh and first coating
compositions with 5% FBS.

| | | Coating Formulation | Log₁₀ | Log₁₀ | Log₁₀ | Log₁₀ | Log₁₀ | Log₁₀ |
|---|---|---|---|---|---|---|---|---|
| Bacteria | | Used | 0 | 5 | 10 | 20 | 30 | 60 |
| | | | Bacteria Reduction at various contact times (min) | | | | | |
| Gram-Positive | CA-MRSA | 5th | / | 0.57 | 2.86 | 6.34 | 6.34 | 6.34 |
| | 40065 | 6th | / | −0.44 | 0.37 | 2.43 | 6.34 | 6.34 |
| | | 1st | / | 0.11 | 0.58 | 1.84 | 6.34 | 6.34 |
| | | 7th | / | −0.22 | 0.68 | 6.34 | 6.34 | 6.34 |
| | | 2nd | / | 0.40 | 0.42 | 0.50 | 0.31 | 0.38 |
| | | | Bacteria Reduction at various contact times (Hrs) | | | | | |
| | | Unchlorinated Samples⁽²⁾ | 1 | 5 | 24 | 24³ | / | / |
| | | Virgin Substrate | 0.17 | 6.34 | 6.34 | 6.34 | / | / |
| | | 5th | 1.05 | 6.34 | 6.34 | 6.34 | / | / |
| | | 6th | 0.19 | 6.34 | 6.34 | 6.34 | / | / |
| | | 1st | 2.19 | 6.34 | 6.34 | 6.34 | / | / |
| | | 7th | -0.32 | 6.34 | 6.34 | 6.34 | / | / |

General Note:
⁽¹⁾Unclorinated samples were kept in 37° C. incubator with ~70% humidity for 24 hours
⁽²⁾5% FBS was added to all samples except as noted

The inventors incubated unchlorinated samples in Table 21 for longer time periods (1, 5 and 24 hours). The experiment was performed in the presence of 5% FBS but for the last time period of 24 hours both 5% FBs and 5% TSB were used. TSB was tested to rule out the possibility that the killing was not due to lack of nutrients. The inventors determined the coating formulations were equally effective in presence of both TSB and FBS.

Table 21A provides a summary the biocidal activity of the 8A (F2V2P1), 8B (F2B1P3) and 8C (F2V3P2) coating compositions when coated on a substrate, then chlorinated at 100 ppm for 60 minutes, and then challenged with 5% FBS. Unchlorinated substrate data are provided for reference. The test bacterium was a Gram-positive CA-MRSA 40065.

TABLE 21A
Summary of biocidal activity of the 8A (F2V2P1), 8B (F2B1P3) and 8C
(F2V3P2) coating compositions with 5% FBS.

| | | | Log Reduction | | |
|---|---|---|---|---|---|
| | | | at Various | | |
| | | | Contact Times (min) | | |
| | | | MRSA Inoculum | | |
| | | | 6.32-log | | |
| Bacteria | | Sample ID | 10 | 30 | 60 |
| Gram- | CA- | Unchlorinated F2V2P1-1 | 0.13 | 0.26 | 1.00 |
| positive | MRSA | Chlorinated F2V2P1-1 | 0.23 | 0.63 | 6.32 |
| | (#40065) | Unchlorinated F2B1P3-1 | 6.32 | 6.32 | 6.32 |
| | | Chlorinated F2B1P3-1 | 2.51 | 6.32 | 6.32 |
| | | Unchlorinated F2V3P2-1 | 0.01 | 0.96 | 6.32 |
| | | Chlorinated F2V3P2-1 | 0.21 | 0.51 | 6.32 |

Table 21B provides a summary the biocidal activity of the 8A (F2V2P1), 8B (F2B1P3) and 8C (F2V3P2) coating compositions when coated on a substrate, then chlorinated at 100 ppm for 60 minutes, and then challenged with 5% TSB. Unchlorinated substrate data are provided for reference. The test bacterium was a Gram-positive CA-MRSA 40065.

TABLE 21B
Summary of biocidal activity of the 8A (F2V2P1), 8B (F2B1P3) and 8C
(F2V3P2) coating compositions with 5% TSB.

| | | | Log Reduction | | |
|---|---|---|---|---|---|
| | | | at Various | | |
| | | | Contact Times (min) | | |
| | | | MRSA Inoculum | | |
| | | | 6.85-log | | |
| Bacteria | | Sample ID | 10 | 30 | 60 |
| Gram- | CA- | Unchlorinated F2V2P1-1 | 0.48 | 0.54 | 0.61 |
| positive | MRSA | Chlorinated F2V2P1-1 | 0.50 | 1.16 | 0.78 |
| | (#40065) | Unchlorinated F2B1P3-1 | 6.85 | 6.85 | 6.85 |
| | | Chlorinated F2B1P3-1 | 0.62 | 0.95 | 1.58 |
| | | Unchlorinated F2V3P2-1 | 0.50 | 0.43 | 0.58 |
| | | Chlorinated F2V3P2-1 | 0.54 | 0.66 | 0.89 |

Table 21C provides a summary the biocidal activity of the 8A (F2V2P1), 8B (F2B1P3) and 8C (F2V3P2) coating compositions when coated on a substrate, then chlorinated at 100 ppm for 60 minutes in PBS. Unchlorinated substrate data are provided for reference. The test bacterium was a Gram-positive CA-MRSA 40065.

TABLE 21C
Summary of biocidal activity of the 8A (F2V2P1), 8B (F2B1P3) and 8C
(F2V3P2) coating compositions in PBS.

| | | | Log Reduction | | |
|---|---|---|---|---|---|
| | | | at Various | | |
| | | | Contact Times (min) | | |
| | | | MRSA Inoculum | | |
| | | | 6.34-log | | |
| Bacteria | | Sample ID | 10 | 30 | 60 |
| Gram- | CA- | Unchlorinated F2V2P1-1 | 0.44 | 0.65 | 1.02 |
| positive | MRSA | Chlorinated F2V2P1-1 | 6.34 | 6.34 | 6.34 |
| | (#40065) | Unchlorinated F2B1P3-1 | 0.69 | 6.34 | 6.34 |
| | | Chlorinated F2B1P3-1 | 6.34 | 6.34 | 6.34 |
| | | Unchlorinated F2V3P2-1 | 0.47 | 0.53 | 0.47 |
| | | Chlorinated F2V3P2-1 | 6.34 | 6.34 | 6.34 |

### Example 5: Coating Compositions for Hard Substrates

While the foregoing examples relate to coating compositions that can be coated on textile substrates, the active compounds and the reference compounds may also be incorporated in other coating formulations for coating hard substrates such as a metal, a metal alloy, a rigid polymer, a wood surface, a previously treated wood surface, and combinations thereof. The presence of the CIG may allow the active compounds and the reference compounds to be incorporated into various polymer systems that are suitable for hard substrates.

In some embodiments of the present disclosure, when the CIG within a coating composition is:
a mono-amine, the CIG may be useful for chain growth polymerization into epoxy or polyurethane systems;
a dual or poly terminated amine, the CIG may allow for curing into epoxy systems through a crosslinking mechanism;
a dual or poly terminated carboxylic acid, the CIG may allow for curing into epoxy or polyurethane systems through a crosslinking mechanism;
a hydroxyl group, or a carboxylic acid group, the CIG may be used to tether molecules to epoxide groups present on a surface, as long as a competitive curing process is not taking place at the same time;
multiple hydroxyl-groups or carboxylic acid groups, the CIG may react into polyurethane polymers through chain growth polymerization and during a cure within a crosslinking reaction;
a vinyl group or vinyl-acetate group, the CIG may react with various base polymers such as vinyl or silicone based systems in the presence of a modified melamine crosslinker through a step growth polymerization process;
a vinyl acetate group, the CIG may react with ester groups in most any polymer backbone through a step growth polymerization process;
a vinyl acetate group, the CIG may homopolymerize to form acrylic or acrylate polymers, or be copolymerized with other moieties to also form vinyl or latex thermoplastic polymers; and
a vinyl functionality of two or greater in copolymerization with unsaturated polyesters and modified polyesters through condensation polymerization with a glycol and diacid monomer. Forming an unsaturated copolymer;
a vinyl functionality of two or greater as a cross-linking agent in unsaturated polyester resins and modified polyester resins. Polymer matrix achieved through radical polymerization. Forming a thermoset matrix via chain growth;
an above-mentioned copolymer with available double or triple bonds utilized as a cross-linking agent in unsaturated polyester resins and modified polyester resins. A polymer matrix may be achieved through radical polymerization. Forming a thermoset matrix via chain growth;
an above-mentioned copolymer with available double or triple bonds utilized with a cross-linking agent (e.g. styrene) and initiator (such as MEKP). A polymer matrix may be achieved through radical polymerization. Forming a thermoset matrix via chain growth;
an alkene or vinyl group, which can homopolymerize to form a polyolefin polymer, or be copolymerized with other moieties to form polyethylene, polypropylene, polybutylene, poly(vinyl chloride), or other thermoplastic polymers through an addition polymerization process, or a radical polymerization process; and
an alkene or vinyl group, which can be co-polymerized with other moieties including but not limited to perfluorocycloalkene, ethylene, vinyl fluoride, vinylidene fluoride (1,1-difluoroethylene), tetrafluoroethylene, chlorotrifluoroethylene, propylene, hexafluoropropylene, perfluoropropylvinylether and perfluoromethylvinylether to form a fluoropolymer through an addition polymerization process, a radical polymerization process, or other polymerization method.

When a hard substrate is coated with a coating composition that includes a compound with at least one of the above-described CIGs, the coated hard substrate will have biocidal activity or the potential for increased biocidal activity.

### Example 6: Compounds for Incorporation into Epoxy Systems

Some embodiments of the present disclosure relate to the use of the compounds described herein that have biocidal activity or the potential for biocidal activity and may be incorporated into an epoxy system, for example as a hardener. A hardener may also be referred to as a cross-linker. In some embodiments of the present disclosure, the integration of the compounds (as described at least here in Example 6) into an epoxy system increases the amount of positive charge within the epoxy polymer and/or provides an N-halamine precursor group within the epoxy polymer. Some embodiments comprise at least two cationic centers, an N-halamine precursor group and at least one CIG. These hardener compounds may be incorporated into an epoxy polymer system during a crosslinking reaction.

One example of a compound that may be incorporated into an epoxy system is referred to herein as cationic DETA and the following general formula (Formula 9):

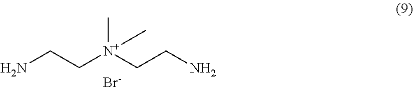

Another example of a suitable compound that may be incorporated into an epoxy system is referred to herein as cationic DETA phosphate has the following general formula (Formula 10):

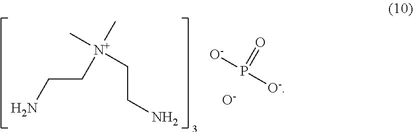

Another example of a suitable compound that may be incorporated into an epoxy system is referred to herein as PIP—C4-BIS-C3-NH₂ or PD and has the following general formula (Formula 11):

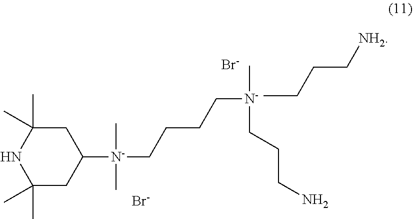

Another example of a suitable compound that may be incorporated into an epoxy system is referred to herein as QAS-QPS tetra-amine and has the following general formula (Formula 12):

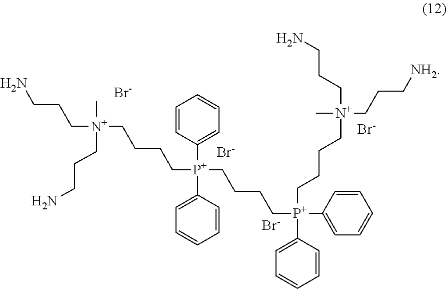

Another example of a suitable compound that may be incorporated into an epoxy system is referred to herein as C4-P—C4-P—C10-BIS-C3-NH₂ and has the following general formula (Formula 13):

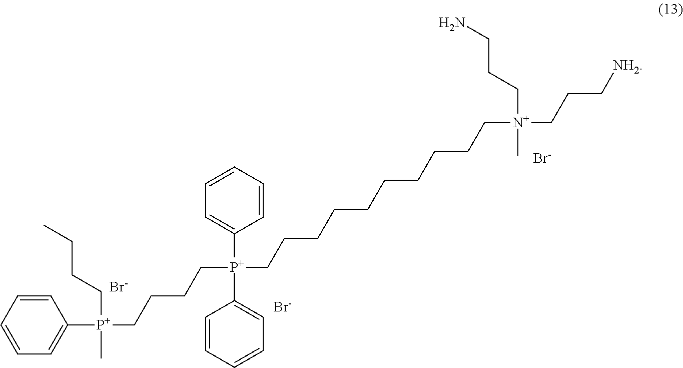

Another example of a suitable compound that may be incorporated into an epoxy system is referred to herein as PIP—C4-P—C4-P—C4-BIS-C3-NH₂ or X2 and has the following general formula (Formula 14):

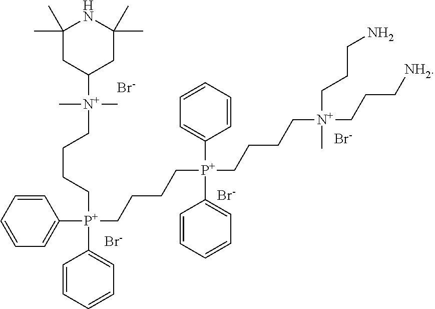

### Example 7: Formulations Including Compounds of Example 6

Some embodiments of the present disclosure relate to at least the following examples of formulations that comprise one or more of the compounds described in Example 6.

Table 22 below summarizes the nomenclature used to describe some of these formulations.

TABLE 22
A summary of formulation nomenclature.
Commercial Products

| | |
|---|---|
| BECKOPOX EP | Type 1 solid epoxy resin as an aqueous dispersion. |
| 2384W/57WA | |
| BECKOCURE EH | Aliphatic polyamine adduct. Suited for anti-corrosion coatings. |
| 2260/41WA | |
| DMP 30 | Epoxy/Amine cure accelerator (2,4,6 |
| | Tris(dimethylaminomethyl)phenol) |
| ADDITOL XW 390 | Flow and wetting agent without silicone. |

Matrix/Binder

| | |
|---|---|
| E2 | Beckocure EH 2260w/41WA and Beckopox EP 2384w/57WA |
| E3 | Beckopox EP 2384w/57WA and Cationic DETA |
| E9 | Beckopox EP 2384w/57WA |
| E10 | Beckopox EP 2384w/57WA + Cationic DETA Phosphate |
| E11 | Beckopox EP 2384w/57WA + QAS/QPS Tertamine |
| E12 | Beckopox EP 2384w/57WA + Phosphonium brush C4-P-C4-P-C10-BIS-C3- |
| | NH2 |
| E13 | Beckopox EP 2384w/57WA + QAS ionic liquid |

Active Compound

| | |
|---|---|
| PD | Diamine Piperidine (PIP-C4-BIS-C3-NH2) |
| X2 | Diamine Phosphonium Peperidine (PIP-C4-P-C4-P-C4-BIS-C3-NH2) |
| Cationic DETA | Cationic hardener (GVK EXT-09R-16 Compound 7) |
| Cationic DETA Phosphate | Cationic hardener (GVK EXT-09R-16 Compound 7) with phosphate |
| | replacement |
| QAS/QPS Tetramine | Quaternary ammonium(QAS), quaternary phosphonium (QPS) |
| | hardener |
| Phosphonium Brush | Phosphonium brush hardener (C4-P-C4-P-C10-BIS-C3-NH2) |
| QAS Tetramine | Quaternary ammonium(QAS) hardener, ionic liquid |

Substrate

| | |
|---|---|
| GS | Galvanized steel |
| SS | Stainless steel |

The following formulations are identified according to the following legend:

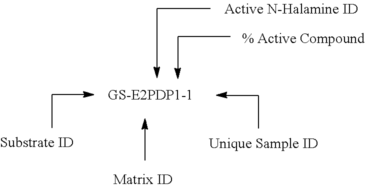

Table 23 provides examples of formulations that comprise one or more of the compounds described in Example 6.

TABLE 23
Formulations with the compounds described in Example 6.

| | Mass (g) | | | |
|---|---|---|---|---|
| Formulations | Theoretical | Practical | Percentage | Notes |
| GS-E2NAP0 | | | Before Curing | Curing at 90 C. for |
| BECKOPOX ® EP | 75.00 | 12.66 | 42.22% | 3 hours and post |
| 2384W/57WA | | | | cure at 130 C. for |
| BECKOPOX ® EH | 100.00 | 16.89 | 56.29% | 0.5 hr |
| 2260/41WA | | | | Make two plagues |
| DMP 30 | 2.66 | 0.45 | 1.50% | Processing: Apply |
| Total: | 177.66 | 30.00 | 100.00% | 2-3 times after |
| | | | | drying with heat |
| | | | | gun |
| GS-E3PDP14-1,2,3 | | | Before Curing | Dissolve PIP_C6_C3_100_1 and |
| BECKOPOCK EP | 100.00 | 37.70 | 75.41% | DETA in water separately and |
| 2384/57W | | | | then mixed together. |
| PIP-C4-BIS-C3-NH2 | 9.09 | 3.43 | 6.86% | Curing at 90 C. for 3 hours and |
| (50%) | | | | post cure at 130 C. for 0.5 hr |
| Cationic DETA (50%) | 3.54 | 1.33 | 2.67% | Make two plagues |
| Water | 18.00 | 6.79 | 13.57% | Processing: Apply 2-3 times after |
| DMP 30 | 1.99 | 0.75 | 1.50% | drying with heat gun |
| Total: | 132.62 | 50.00 | 100.00% | AHEW = 94.71 |
| GS-E10PDP13-1,2,3 | | | Before Curing | Dissolve PIP_C6_C3_100_1 and |
| BECKOPOCK EP | 100.00 | 37.27 | 74.53% | DETA-phosphate in water |
| 2384/57W | | | | separately and then mixed |
| PIP-C4-BIS-C3-NH2 | 10.00 | 3.73 | 7.45% | together. |
| (50%) | | | | Curing at 90 C. for 3 hours and |
| DETA-phosphate | 4.17 | 1.55 | 3.10% | post cure at 130 C. for 0.5 hr |
| (50%) | | | | Make two plagues |
| Water | 18.00 | 6.71 | 13.42% | Processing: Apply 2-3 times after |
| DMP 30 | 2.00 | 0.75 | 1.49% | drying with heat gun |
| Total: | 134.17 | 50.00 | 100.00% | AHEW = 96.59 |
| GS-E11PDP13-1,2,3 | | | Before Curing | Dissolve PIP_C6_C3_100_1 and |
| BECKOPOCK EP | 100.00 | 35.55 | 71.11% | QAS-QPS in water separately and |
| 2384/57W | | | | then mixed together. |
| PIP-C4-BIS-C3-NH2 | 10.00 | 3.56 | 7.11% | Curing at 90 C. for 3 hours and |
| (50%) | | | | post cure at 130 C. for 0.5 hr |
| QAS-QPS (50%) | 10.53 | 3.74 | 7.49% | Make two plagues |
| Water | 18.00 | 6.40 | 12.80% | Processing: Apply 2-3 times after |
| DMP 30 | 2.10 | 0.75 | 1.49% | drying with heat gun |
| Total: | 140.63 | 50.00 | 100.00% | AHEW = 139.99 |
| GS-E11NAP0-1,2,3 | | Rev 1- | Before Curing | Curing at 90 C. for 3 hours and |
| | | Released | | post cure at 130 C. for 0.5 hr |
| | | on | | Make two plagues |
| | | Sep. | | Processing: Apply 2-3 times after |
| | | 7, 2016 | | drying with heat gun |
| BECKOPOCK EP | 100.00 | 35.41 | 70.83% | AHEW = 143.6 |
| 2384/57W | | | | |
| QAS-QPS | 21.06 | 7.46 | 14.92% | |
| Water | 18.00 | 6.37 | 12.75% | |
| DMP 30 | 2.13 | 0.75 | 1.51% | |
| Total: | 141.19 | 50.00 | 100.00% | |
| GS-E11PDP3-1,2,3 | | | Before Curing | Dissolve PIP_C6_C3_100_1 and |
| BECKOPOCK EP | 100.00 | 35.47 | 70.94% | QAS-QPS in water separately and |
| 2384/57W | | | | then mixed together. |
| PIP-C4-BIS-C3-NH2 | 4.00 | 1.42 | 2.84% | Curing at 90 C. for 3 hours and |
| (20%) | | | | post cure at 130 C. for 0.5 hr |
| QAS-QPS (80%) | 16.85 | 5.98 | 11.95% | Make two plagues |
| Water | 18.00 | 6.38 | 12.77% | Processing: Apply 2-3 times after |
| DMP 30 | 2.12 | 0.75 | 1.50% | drying with heat gun |
| Total: | 140.97 | 50.00 | 100.00% | AHEW = 142.16 |
| GS-E9X2P27-1,2,3 | | | Before Curing | Curing at 90 C. for 3 hours and |
| BECKOPOCK EP | 100.00 | 18.29 | 60.97% | post cure at 130 C. for 0.5 hr |
| 2384/57W | | | | Make two plagues |
| PIP-C4-P-C4-P-C4- | 43.55 | 7.97 | 26.56% | Processing: Apply 2-3 times after |
| BIS-C3-NH2 | | | | drying with heat gun |
| Water | 18.00 | 3.29 | 10.97% | AHEW = 296.97 |
| DMP 30 | 2.46 | 0.45 | 1.50% | |
| Total: | 164.01 | 30.00 | 100.00% | |
| GS-E13NAP0-1,2,3 | | | Before Curing | Instead of roller, use paint brush |
| D.E.R 332 (DGEBA) | 100 | 10.87 | 72.44% | to apply onto the surface. Curing |
| QAS Ionic Liquid | 35.97 | 3.91 | 26.06% | at 90 C. for 3 hours and post cure |
| DMP30 | 2.07 | 0.22 | 1.50% | at 130 C. for 0.5 hr |
| Total: | 138.04 | 15.00 | 98.50% | Make two plagues |
| | | | | AHEW = 63.36 |
| GS-E12NAP0-1,2,3 | | | Before Curing | Curing at 90 C. for 3 hours and |
| BECKOPOCK EP | 100.00 | 19.07 | 63.55% | post cure at 130 C. for 0.5 hr |
| 2384/57W | | | | Make two plagues |
| C4-P-C4-P-C10-BIS- | 36.99 | 7.05 | 23.51% | Processing: Apply 2-3 times after |
| C3-NH2 | | | | drying with heat gun |
| Water | 18.00 | 3.43 | 11.44% | AHEW = 252.2 |
| DMP 30 | 2.36 | 0.45 | 1.50% | |
| Total: | 157.35 | 30.00 | 100.00% | |
| GS-E9PDP15 | | | Before Curing | Curing at 90 C. for 3 hours and |
| BECKOPOCK EP | 100.00 | 36.17 | 72.33% | post cure at 130 C. for 0.5 hr |
| 2384/57W | | | | Make two plagues |
| PIP-C4-BIS-C3-NH2 | 18.18 | 6.58 | 13.15% | Processing: Apply 2-3 times after |
| (50%) | | | | drying with heat gun |
| Water | 18.00 | 6.51 | 13.02% | AHEW = 136.37 |
| DMP 30 | 2.07 | 0.75 | 1.50% | |
| Total: | 138.25 | 50.00 | 100.00% | |

### Example 7A: Further Formulations Including Compounds of Example 6

Some embodiments of the present disclosure relate to at least the following examples of formulations that comprise one or more of the compounds described in Example 6.

Table 23A below summarizes the nomenclature used to describe some of these formulations.

TABLE 23A
A summary of formulation nomenclature.

| | |
|---|---|
| Product ID | Prescription |

Commercial Products

| | |
|---|---|
| BECKOPOX EP 2384W/ | Type 1 solid epoxy resin as a aqueous |
| 57WA | dispersion |
| Ancarez AR555 | Waterborne solid epoxy dispersion |
| | delivered at 55% solids in water |
| DMP30 | Epoxy/Amine cure accelerator (2,4,6 |
| | Tris(dimethylaminomethyl)phenol) |
| DMAPAPA | Epoxy/Amine cure accelerator (N,N- |
| | Dimethyldipropylenetriamine) |
| Dynol 607 | Air Products nonionic organic superwetter |
| Surfynol 420 | Air Products nonionic dynamic wetting |
| | agent and molecular defoamer |

Matrix/Binder

| | |
|---|---|
| E15 | Waterborne epoxy: Beckopox EP |
| | 2384w/57WA |
| E16 | Waterborne epoxy: Air Products Ancarez |
| | AR555 |

Active Compounds

| | |
|---|---|
| PD - Formula 11 | Diamine Piperidine (PIP-C4-BIS-C3-NH2) |
| X2 - Formula 14 | Diamine QAS/QPS |

The following formulations are identified according to the following legend:

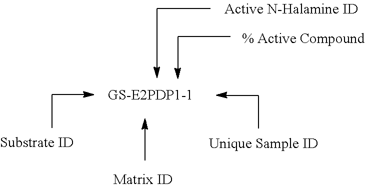

Table 23B provides examples of formulations that comprise one or more of the compounds described in Example 6.

TABLE 23B
Formulations with the compounds described in Example 6.

| Formulations | Mass (g) | Percentage | Notes |
|---|---|---|---|
| E16PDP19 | | | |
| Ancarez AR555 | 30.98 | 77.44% | PD compound was in liquid |
| PIP-C4-BIS-C3-NH2 (PD) | 7.68 | 19.20% | state - no solvent was required. |
| Solvent: Water & Acetone | | | But practically, approx. 1-2 gm |
| DMP 30 | 0.93 | 2.32% | of water was added to lower the |
| Surfynol 420 | 0.42 | 1.04% | viscosity to ensure a thorough |
| Total: | 40 | 100% | mixing with epoxy emulsions. |
| E16X2P21 | | | |
| Ancarez AR555 | 17.45 | 58.17% | |
| PIP-C4-P-C4-P-C4-BIS- | 6.45 | 21.52% | Dissolve compound in water, |
| C3-NH2 | | | followed by addition to epoxy |
| D.E.H 20 | .07 | 0.22% | binder. DMP 30 is then added |
| Solvent: Water | 5.24 | 17.45% | along with D.E.H 20 to provide |
| DMP 30 (3 ppr) | 3.00 | 1.75% | a smaller amine group during |
| Surfynol 420 (.9% of MT) | .27 | 0.90% | curing for crosslinking |
| Total: | 30.00 | 100% | Surfynol is added for wetting of |
| | | | metal surface. |

### Example 8: Data Collected from Hard-Substrates Coated in Formulations from Example 7

The coated hard-substrates were subjected to a halogenation step by exposure chlorine. The amount of chlorine that loaded on to each coated hard-substrate was then evaluated using iodometric titration with sequential quenching with sodium thiosulfate, as described herein above.

Tables 24A and 24B provide example data of chlorination trends for measuring chlorine (ppm) that was loaded onto a hard-substrate that was coated with E9DP15 and exposed to 200 ppm chlorine (Table 24A) or 100 ppm (Table 24B) and shaken for the time increments indicated.

TABLE 24A
Chlorination trends for a hard substrate coated with E9DP15 and exposed
to 200 ppm of chlorine.

| Sample | Active Chlorine | STD |
|---|---|---|
| E9DPP15-6 (5 minute) | 5.6016 | 1.9052 |
| E9DPP15-6 (10 minute) | 9.1650 | 2.3830 |
| E9DPP15-6 (15 minute) | 7.5130 | 0.6350 |

TABLE 24B
Chlorination trends for a hard substrate coated with E9DP15 and exposed
to 100 ppm of chlorine.

| Sample | Active Chlorine | STD |
|---|---|---|
| E9DPP15-9 (10 minute) | 6.11 | 0.23 |
| E9DPP15-5 (60 minute) | 5.9961 | 1.0189 |

Table 25 summarizes the active chlorination results measured by iodometric titration performed on coated hard-substrates and exposed to 200 ppm of chlorine for 10 minutes.

TABLE 25
Active chlorine results for various coated hard-substrates.

| Sample | Active Chlorine | STD |
|---|---|---|
| E11NAP0 | −0.52 | 0.90 |
| E11PDP3 | 0.09 | 0.25 |
| E9X2P27 | 9.93 | 1.34 |

Tables 26A and 26B summarize the ionic titration analysis for assessing the amount of positive charge that was present on the surface of hard substrates that were coated with the formulations indicated. Briefly, the samples were cut into 1 cm×1 cm squares and then placed into a 1% (wt) aqueous solution of fluorescein (sodium salt) for about 20 minutes. The samples were then rinsed with deionized (DI) water and placed in a 0.1 wt % aqueous solution of cetyltrimethylammonium chloride. The samples were then shaken for about 40 minutes in a wrist-action shaker. After shaking, 10% V/V of phosphate buffer pH 8.0 was added. The absorbance of the resulting solution was then measured. The molar extinction coefficient used was 77 nM-1 cm-1. The calculations were based upon those described in Zander et al. (2008, Charge Density Quantification of Antimicrobial Efficacy, Army Research Laboratory, August), and Murata et al. (2007, Permanent, non-leaching antibacterial surfaces-2: How high density cationic surfaces kill bacterial cells, Biomaterials 28. July 2007).

TABLE 26A
Summary of surface charge assessment on hard-substrates coated with
E9DP15 and E9XIP13 formulations.

| | Charge Density | |
|---|---|---|
| Sample | (N⁺/cm²) | STD |
| E9PDP15-3 | 1.54E+16 | 3.55E+15 |
| E9PDP15-5 (DMP 30) | 1.69E+16 | 2.82E+15 |
| E9PDP15-9 (DMP 30) | 6.86E+15 | 6.51E+13 |
| E9PDP15-7 (Additol xw 390) | 1.60E+16 | 2.84E+14 |
| E9XIP13-1 | 1.54E+16 | 8.63E+14 |

TABLE 26B
Summary of surface charge assessment on hard-substrates coated with
formulations indicated.

| | Charge Density | |
|---|---|---|
| Sample | (N+/cm2) | STD |
| E3PDP14-1 | 8.44784E+15 | 6.19E+14 |
| E10PDP13-3 | 4.16135E+15 | 2.21E+14 |
| E11PDP13-2 | 6.24202E+15 | 7.30E+14 |

TABLE 26C
Summary of surface charge assessment on hard-substrates coated with
formulations indicated.

| | Charge Density | |
|---|---|---|
| Sample | (N+/cm2) | STD |
| E11NAP0 | 4.27996E+15 | 4.10E+14 |
| E11PDP3 | 1.62004E+15 | 1.06E+14 |
| E9X2PDP27 | 9.55832E+15 | 3.14E+15 |

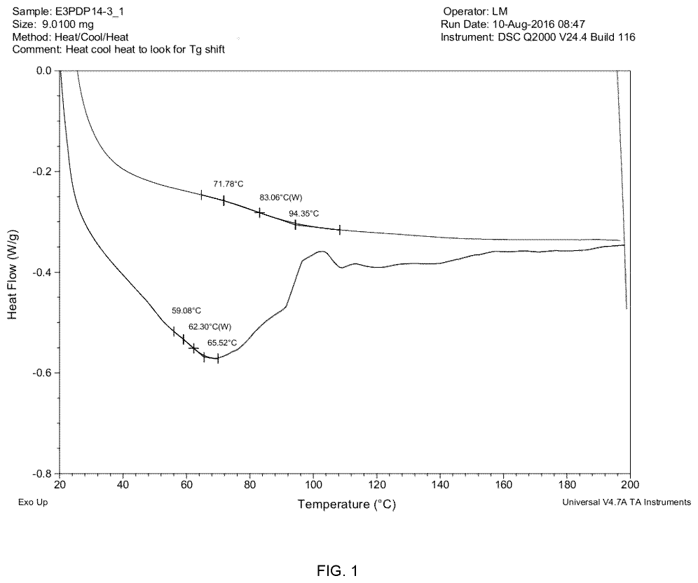

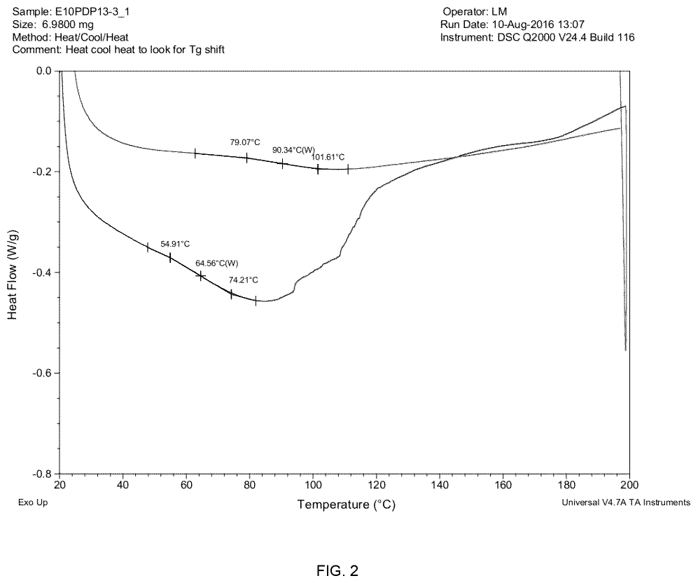

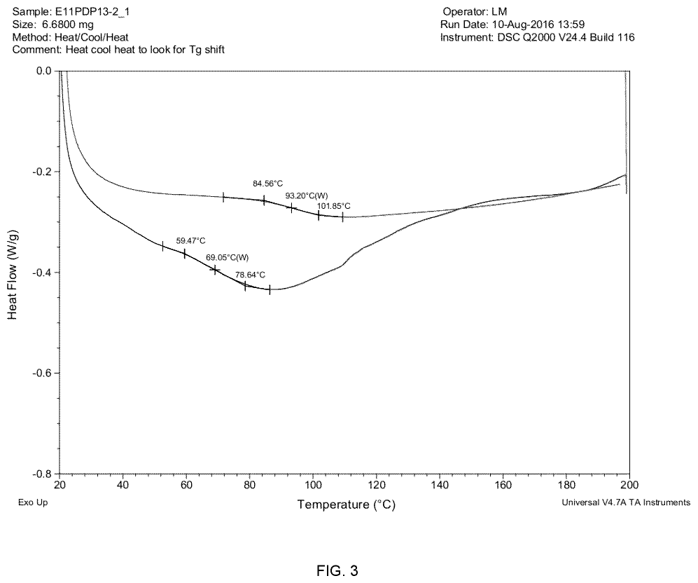

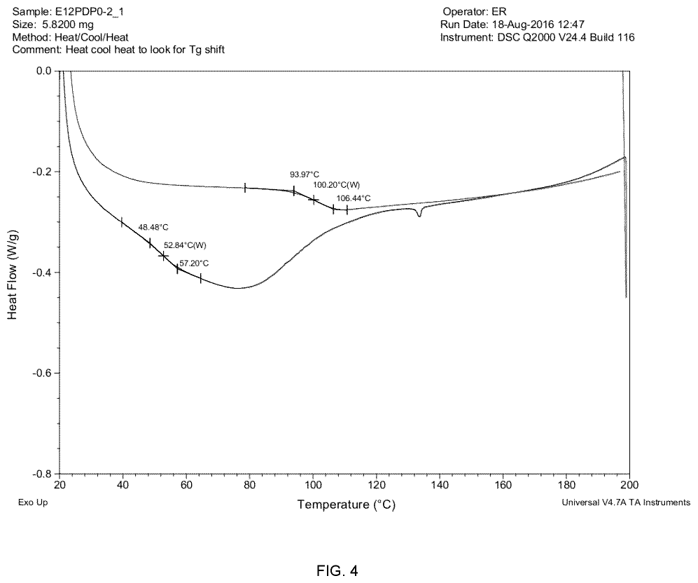

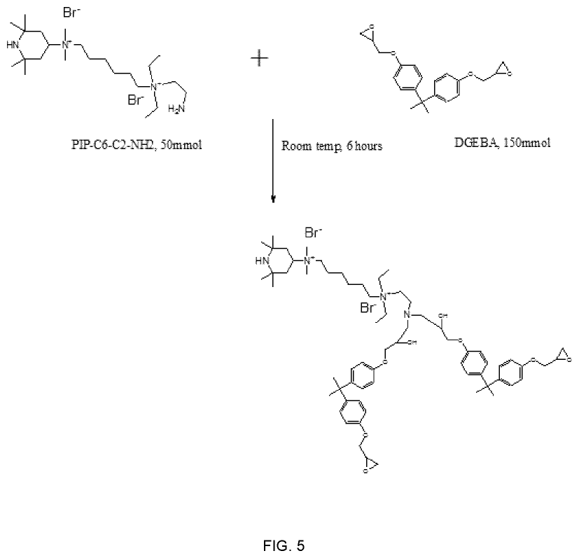

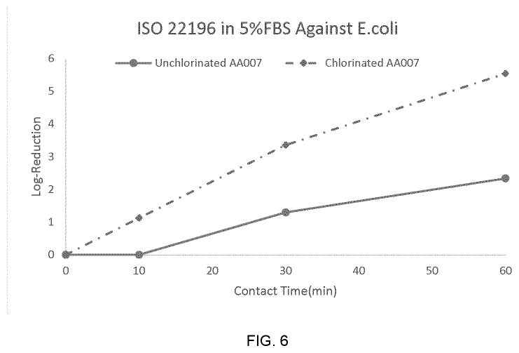

FIG. 1, FIG. 2, FIG. 3 and FIG. 4 each show examples of data generated with differential scanning calorimetry (DSC) analysis of the coating formulations disclosed therein using TA Instruments Q2000 DSC Analyzer. Briefly, the epoxy coating was scraped off of the coated hard-substrates after which, the thin film was trimmed and deposited into a TMA DSC pan. Multiple layers of the film were stacked in the pan to ensure there was enough material for testing requirements. The lid was then pressed into the pan and the test was completed from 20° C. to 200° C. at a ramp rate of 10° C./min. A heat-cool-heat program was used, with a cooling rate of 20° C./min. The glass transition temperature is then analyzed using the Universal V4.7A software package.

Tables 27 to 35 summarize the biocidal activity of the coated hard-substrates as assessed using the ISO 22196 methodology. Briefly, control and chlorinated samples of the coated hard-substrates (chlorinated at 200 ppm for 10 minutes) were challenged with E. coli (ATCC 25922). Using a pipette, 200 μL of test inoculum were transferred at a concentration of 1-2×10⁶ CFU/mL (in sterile DI water, 5% fetal bovine serum or 100% Mueller-Hinton broth) onto a 50 mm×50 mm plastic test surface in a sterile petri dish. The test inoculum was covered with a piece of PET (polyethylene terephthalate) film that measured 40 mm×40 mm. A slight pressure was applied to the film so that the test inoculum spread to the edges. The test inoculum was kept within the edges of the film and was capped with the lid of the petri dish. Contact times for the samples were 10, 30 and 60 minutes. Then the samples were quenched with 10 mL of sterile 0.05 M sodium thiosulfate solution to remove all oxidative chlorine in the petri dish. This quenching step was followed by repetitive washing and 1 minute of sonication. Serial dilutions of the solutions of vortexed and sonicated bacteria were made using DI water, and they were plated on Tryptone soya agar. The plates were incubated at 37° C. for about 16 hours to about 18 hours, and viable bacterial colonies were recorded for kill kinetics analysis. The logarithm reduction was determined as follows:

Log reduction=log (A/B) if B>0; =log (A) if B=0
A=the number of bacteria added onto the control/test specimen surface.
B=the number of bacteria recovered from the inoculated test specimen swatches.

TABLE 27
Summary of biocidal activity of hard-substrates that were coated with
the formulations indicated herein in 5% FBS.

| | | | Log Reduction | | |
|---|---|---|---|---|---|
| | | | at Various | | |
| | | | Contact Times (min) | | |
| | | | E. coli Inoculum | | |
| | | | 5.40-log | | |
| Bacteria | | Sample ID | 10 | 30 | 60 |
| Gram- | E. coli | Control E2NAP0 | / | / | 0.41 |
| negative | ATCC | Unchlorinated E3PDP14-1&2 | 0.00 | 0.36 | 1.07 |
| | 25922 | Unchlorinated E10PDP13-1&3 | 0.17 | 0.84 | 1.43 |
| | | Unchlorinated E11PDP13-1&2 | 0.33 | 2.32 | 5.40 |
| | | Chlorinated E3PDP14-1&2 | 0.32 | 0.76 | 1.77 |
| | | Chlorinated E10PDP13-1&3 | 0.41 | 0.98 | 1.53 |
| | | Chlorinated E11PDP13-1&2 | 0.58 | 1.44 | 2.14 |

TABLE 28
Summary of biocidal activity of hard-substrates that were coated with the
formulations indicated herein in MH broth.

| | | | Log Reduction | | |
|---|---|---|---|---|---|
| | | | at Various | | |
| | | | Contact Times (min) | | |
| | | | E. coli Inoculum | | |
| | | | 5.44-log | | |
| Bacteria | | Sample ID | 10 | 30 | 60 |
| Gram- | E. coli | Control E2NAP0 | / | / | 0.45 |
| negative | ATCC | Unchlorinated E3PDP14-1&2 | / | 0.41 | 0.33 |
| | 25922 | Unchlorinated E10PDP13-1&3 | / | 0.32 | 0.57 |
| | | Unchlorinated E11PDP13-1&2 | / | 0.36 | 1.30 |
| | | Chlorinated E3PDP14-1&2 | 0.41 | 0.33 | 0.35 |
| | | Chlorinated E10PDP13-1&3 | 0.23 | 0.29 | 0.27 |
| | | Chlorinated E11PDP13-1&2 | 0.31 | 0.37 | 0.32 |

TABLE 29
Summary of biocidal activity of hard-substrates that were coated
with the formulations indicated herein in 5% FBS.

| | | | Log Reduction at Various | | |
|---|---|---|---|---|---|
| | | | Contact Times (min) | | |
| | | | E. coli Inoculum 5.46-log | | |
| Bacteria | | Sample ID | 10 | 30 | 60 |
| Gram- | E. coli | Control E2NAP0 | / | / | TMTC |
| negative | ATCC | Unchlorinated E11NAP0 | TMTC | 2.31 | TMTC |
| | 25922 | Unchlorinated E11PDP3 | 0.46 | 1.20 | 2.98 |
| | | Unchlorinated E12NAP0 | 0.32 | 0.37 | 0.50 |
| | | Unchlorinated E9X2P27 | 2.45 | 5.46 | 5.46 |
| | | Unchlorinated E13NAP0 | 5.46 | 5.46 | 5.46 |
| | | Chlorinated E11NAP0 | 0.29 | 0.57 | 0.63 |
| | | Chlorinated E11PDP3 | 0.65 | 0.81 | 1.89 |
| | | Chlorinated E9X2P27 | 2.61 | 5.46 | 5.46 |

TMTC = Too Many Too Count

TABLE 30
Summary of biocidal activity of hard-substrates that were coated
with the formulations indicated herein in MH broth.

| | | | Log Reduction | | |
|---|---|---|---|---|---|
| | | | at Various | | |
| | | | Contact Times (min) | | |
| | | | E. coli Inoculum | | |
| | | | 5.36-log | | |
| Bacteria | | Sample ID | 30 | 60 | / |
| Gram- | E. coli | Control E2NAP0 | / | 0.28 | / |
| negative | ATCC | Unchlorinated E11NAP0 | 0.27 | 0.35 | / |
| | 25922 | Unchlorinated E11PDP3 | 0.15 | 0.47 | / |
| | | Unchlorinated E12NAP0 | 0.27 | 0.17 | / |
| | | Unchlorinated E9X2P27 | 5.36 | 5.36 | / |
| | | Unchlorinated E13NAP0 | 5.36 | 5.36 | / |
| | | Chlorinated E11NAP0 | 0.21 | 0.26 | / |
| | | Chlorinated E11PDP3 | 0.84 | 0.97 | / |
| | | Chlorinated E9X2P27 | 5.36 | 5.36 | / |

TABLE 31
Summary of biocidal activity of hard-substrates that were coated
with the formulations indicated herein in DI water.

| | | | Log Reduction | | |
|---|---|---|---|---|---|
| | | | at Various | | |
| | | | Contact Times (min) | | |
| | | | E. coli Inoculum | | |
| | | | 5.42-log | | |
| Bacteria | | Sample ID | 10 | 30 | 60 |
| Gram- | E. coli | Control E2NAP0 | / | / | 0.67 |
| negative | ATCC | Unchlorinated E9PDP15-13 | 1.02 | 5.42 | 5.42 |
| | 25922 | Unchlorinated E11PDP13-1&2 | −0.43 | 5.42 | 5.42 |
| | | Chlorinated E9PDP15-13 | 5.42 | 5.42 | 5.42 |
| | | Chlorinated E11PDP13-1&2 | 1.24 | 5.42 | 5.42 |

TABLE 32
Summary of biocidal activity of hard-substrates that were coated with the
formulations indicated herein in 5% FBS at repetitive contact intervals and washing
with DI water.

| | | | Log Reduction at Repetitive Contact Intervals | | | | |
|---|---|---|---|---|---|---|---|
| | | | E. coli Inoculum 5.29-log | | | | |
| Bacteria | | Sample ID | 1 | 2 | 3 | 4 | 5 |
| Gram- | E. coli | Control E2NAPO | 0.15 | 0.16 | −0.81 | −1.30 | −1.53 |
| negative | ATCC | Unchlorinated E9PDP15 | 5.29 | 2.33 | 1.38 | 0.72 | 0.19 |
| | 25922 | Unchlorinated E11PDP13 | 5.29 | 1.33 | 0.77 | 0.07 | −0.97 |
| | | Chlorinated E9PDP15 | 5.29 | 1.68 | 0.79 | −0.35 | −0.62 |
| | | Chlorinated E11PDP13 | 5.29 | 2.33 | 1.14 | 0.41 | −0.67 |

TABLE 33
Summary of biocidal activity of hard-substrates that were coated with the
formulations indicated herein in 5% FBS at repetitive contact intervals and washing
with 0.1% SDS.

| | | | Log Reduction at Repetitive Contact Intervals | | | | |
|---|---|---|---|---|---|---|---|
| | | | E. coli Inoculum 5.69-log | | | | |
| Bacteria | | Sample ID | 1 | 2 | 3 | 4 | 5 |
| Gram- | E. coli | Unchlorinated E9PDP15 | 5.69 | 5.69 | 2.51 | 0.11 | 1.28 |
| negative | ATCC | Unchlorinated E11PDP13 | 5.69 | −0.02 | −0.19 | −0.64 | 0.28 |
| | 25922 | Chlorinated E9PDP15 | 5.69 | 2.73 | 1.38 | −0.19 | 1.19 |
| | | Chlorinated E11PDP13 | 5.69 | 0.67 | −0.22 | −0.81 | 0.64 |

TABLE 34
Summary of biocidal activity of hard-substrates that were coated with the
formulations indicated herein in DI water at repetitive contact intervals of one hour and
washing with 0.1% SDS.

| | | | Log Reduction at Repetitive Contact Intervals | | | | |
|---|---|---|---|---|---|---|---|
| | | | E. coli Inoculum 5.69-log | | | | |
| Bacteria | | E9PDP15 | 1 | 2 | 3 | 4 | 5 |
| Gram- | E. coli | Unchlorinated SDS Rinse | 5.86 | 5.86 | 5.86 | 5.86 | 5.86 |
| negative | ATCC | Unchlorinated SDS | 5.86 | 5.86 | 5.86 | 5.86 | 5.86 |
| | 25922 | Sonicated | | | | | |
| | | Chlorinated SDS Rinse | 5.86 | 5.86 | 5.86 | 5.86 | 5.86 |
| | | Chlorinated SDS | 5.86 | 5.86 | 5.86 | 5.86 | 5.86 |
| | | Sonicated | | | | | |

TABLE 35
Summarizes the biocidal activity of hard-substrates that were coated
with the E9DP15 formulation.

| | | | Log Reduction at Various | | |
|---|---|---|---|---|---|
| | | | Contact Times (min) | | |
| | | | E. coli Inoculum | | |
| Bacteria | | Formulation E9PDP15 | 10 min | 30 min | 60 min |
| Gram- | E. coli | Unchlorinated: DI Water | 1.02 | 5.42 | 5.42 |
| negative | ATCC | Chlorinated: DI Water | 5.42 | 5.42 | 5.42 |
| | 25922 | Unchlorinated: 5% FBS | 1.13 | 3.09 | 5.40 |
| | | Chlorinated: 5% FBS | 0.47 | 1.50 | 5.40 |
| | | Unchlorinated: MH | 0.84 | 1.56 | 2.09 |
| | | Broth | | | |
| | | Chlorinated: MH Broth | 0.84 | 1.29 | 2.91 |

Without being bound by any particular theory, the data in Table 35 represent formulation E9PDP15 that includes the compound PIP—C4-BIS-C3-NH₂. The general trend indicates that the antibacterial activity may be decreased in the presence of organic load (i.e. FBS or MH). The chlorinated samples may have performed relatively worse in organic load due to organic matter neutralizing the oxidative chlorine and changing the solutions pH. E. coli killing is pH sensitive, slight change in pH may alter this killing mechanism.

TABLE 36
Summarizes the biocidal activity of hard-substrates that were
coated with the E11PDP13 formulation.

| | | | Log Reduction at Various | | |
|---|---|---|---|---|---|
| | | | Contact Times (min) | | |
| | | | E. coli Inoculum | | |
| Bacteria | | Formulation E11PDP13 | 10 min | 30 min | 60 min |
| Gram- | E. coli | Unchlorinated: DI Water | −0.43 | 5.42 | 5.42 |
| negative | ATCC | Chlorinated: DI Water | 1.24 | 5.42 | 5.42 |
| | 25922 | Unchlorinated: 5% FBS | 0.33 | 2.32 | 5.40 |
| | | Chlorinated: | 0.58 | 1.44 | 2.14 |
| | | 5% FBS | | | |
| | | Unchlorinated: MH | / | 0.36 | 1.30 |
| | | Broth | | | |
| | | Chlorinated: MH Broth | 0.31 | 0.37 | 0.32 |

Without being bound by any particular theory, the data in Table 36 represent the formulation E11PDP13 that includes the compound PIP—C4-BIS-C3-NH₂ and the QAS-QPS Tetramine hardener. A 50% stoichiometric ratio was used for the available amine groups. The QAS-QPS hardener was designed to allow the cationic centers of phosphonium and ammonium to quench the proteins and allow PIP—C4-BIS-C3-NH₂ to kill the bacteria while providing a highly positively charged surface. In general, the formulation performs in DI water with chlorinated and unchlorinated surfaces. In 5% FBS there was a higher efficacy in the unchlorinated surfaces, corresponding to the E9PDP15 data. The formulation E11PDP13 performed poorly in high organic load. The tetramine hardener may not perform any significant biocidal activity on the contact surface. This lack of activity may be due to the geometry of the molecule, whereby the crosslinking does not allow the compound to be in an effective orientation to provide biocidal functionality.

TABLE 37
Summarizes the biocidal activity of hard-substrates that were coated
with an epoxy coating formulation and the QAS-QPS tetramine
compound as a hardener.

| | | | Log Reduction | | |
|---|---|---|---|---|---|
| | | | at Various | | |
| | | | Contact Times (min) | | |
| | | | E. coli Inoculum | | |
| Bacteria | | Sample ID | 10 | 30 | 60 |
| Gram- | E. coli | Unchlorinated | 1.13 | 3.09 | 5.40 |
| negative | ATCC | E9PDP15 0% | | | |
| | 25922 | Unchlorinated E11PDP13 | 0.33 | 2.32 | 5.40 |
| | | 50% | | | |
| | | Unchlorinated E11PDP3 | 0.46 | 1.20 | 2.98 |
| | | 80% | | | |
| | | Unchlorinated E11NAP0 | TMTC | 2.31 | TMTC |
| | | 100% | | | |
| | | Chlorinated E9PDP15 0% | 0.47 | 1.50 | 5.40 |
| | | Chlorinated E11PDP13 | 0.58 | 1.44 | 2.14 |
| | | 50% | | | |
| | | Chlorinated E11PDP3 80% | 0.65 | 0.81 | 1.89 |
| | | Chlorinated E11NAP0 | 0.29 | 0.57 | 0.63 |
| | | 100% | | | |

The QAS-QPS hardener was varied at 100%, 80%, and 50% of available reacting amine groups in blends with PIP—C4-BIS-C3-NH₂. A data point of 100% PIP—C4-BIS-C3-NH₂ was included for reference. This was done to study the effect of the QAS-QPS hardener regarding kill kinetics in 5% FBS. These results may indicate a reduction in biocidal activity of the formulation as the QAS-QPS hardener content is increased. Without being bound by any particular theory, this reduced biocidal activity may be due to a hindrance in the ability of the PIP—C4-BIS-C3-NH₂ molecule to perform the anti-microbial action. In general, the surface availability of the QAS-QPS structure may be statistically lower than expected and the phosphonium groups may be unavailable to provide any significant biocidal activity. This may be correlated with the lower surface charge density values provided above for these samples.

TABLE 38
Summarizes the biocidal activity of hard-substrates that were coated
with an epoxy coating formulation and the QAS-QPS tetramine
compound as a hardener in MH broth.

| | | | Log Reduction | | |
|---|---|---|---|---|---|
| | | | at Various | | |
| | | | Contact Times (min) | | |
| | | | E. coli Inoculum | | |
| Bacteria | | Sample ID | 10 | 30 | 60 |
| Gram- | E. coli | Unchlorinated E9PDP15 0% | 0.84 | 1.56 | 2.09 |
| negative | ATCC | Unchlorinated E11PDP13 | / | 0.36 | 1.30 |
| | 25922 | 50% | | | |
| | | Unchlorinated E11PDP3 80% | / | 0.15 | 0.47 |
| | | Unchlorinated E11NAP0 | / | 0.27 | 0.35 |
| | | 100% | | | |
| | | Chlorinated E9PDP15 0% | 0.84 | 1.29 | 2.91 |
| | | Chlorinated E11PDP13 50% | 0.31 | 0.37 | 0.32 |
| | | Chlorinated E11PDP3 80% | / | 0.84 | 0.97 |
| | | Chlorinated E11NAP0 100% | / | 0.21 | 0.26 |

The QAS-QPS hardener was varied at 100%, 80%, and 50% of available reacting amine groups in blends with the compound PIP—C4-BIS-C3-NH₂. A data point of 100% PIP—C4-BIS-C3-NH₂ was included for reference. This is a study on the effect of the QAS-QPS hardener regarding kill kinetics in MH Broth. These results may indicate that the addition of the tetra functional QAS-QPS hardener compound has no significant impact on biocidal activity of the coated hard-substrate. The general trend indicates poor performance overall in unchlorinated and chlorinated surfaces. This may be due to quenching of the proteins.

TABLE 39
Summarizes the biocidal activity of hard-substrates that were coated with the
E9PDP15 formulation and then subjected to various washing steps.

| | | | Log Reduction at Various Contact Times (min) | | | | |
|---|---|---|---|---|---|---|---|
| | | Chlorinated | E. coli Inoculum | | | | |
| Bacteria | | E9PDP15 | 1 | 2 | 3 | 4 | 5 |
| Gram- | E. coli | Water Rinse: 5% FBS | 5.29 | 1.68 | 0.79 | −0.35 | −0.62 |
| negative | ATCC | 0.1% SDS Rinse: 5% FBS | 5.69 | 2.73 | 1.38 | −0.19 | 1.19 |
| | 25922 | 0.1% SDS Sonicator: | 5.86 | 5.86 | 5.86 | 5.86 | 5.86 |
| | | DI Water | | | | | |
| | | 0.1% SDS Rinse: | 5.86 | 5.86 | 5.86 | 5.86 | 5.86 |
| | | DI Water | | | | | |

The washing technique after the primary bacterial challenges may have a small effect on biocidal activity. The inventors observed that using 0.1% SDS is better than distilled water. Washing with detergent resulted in the antimicrobial capacity returning to its original level. Without being bound by any particular theory, it is likely that material from the dead cells accumulates on the surface through a hydrophobic interaction. The dead cellular material was then removed by the detergent with the concomitant restoration of the antimicrobial activity of the surface of the coated hard-substrate. Further washing was performed in 5% FBS and DI water to observe any effect of organic load on the repetitive challenge. The results may indicate that regardless of the cleaning method without organic load the performance is continuous.

The results may also suggest that proteins appear to quench the surface and inhibit biocidal activity in chlorinated and unchlorinated samples. Without being bound by any particular theory, the organic load with 5% FBS may form a layer over the coated surface via ionic interaction with the cationic moiety, which may hinder the active compound and the bacteria. In absence of organic load the results showed relatively consistent biocidal activity in 1 hour even after five washes. This may confirm that proteins are effecting the biocidal activity over multiple applications in this method.

Formulations with the PIP—C4-BIS-C3-NH₂ compound perform well in PBS/DI Water and FBS and does not produce a zone of inhibition in 24 hours. These formulations also can achieve a good degree of cure and are soluble in water. These compounds, however, do not have high biocidal activity in high organic load environments such as MH Broth.

The QAS-QPS tetramine compound was designed to be highly reactive while providing multiple quaternary ammonium and phosphonium cationic sites. This cationic combination has been shown in literature to have antimicrobial properties when challenged with E. coli in organic load. The structure is a tetramine with two cationic ammoniums and two cationic phosphoniums. Phosphonium has also been shown to provide ample resistance to adsorption of proteins, the intended effect of this compound was to contribute to the resistance of protein adsorption. Additionally, this compound included Br—anions (counter ions). There is no N-halamine functionality included in this compound.

The C4-P—C4-P—C, 10-BIS-C3-NH₂ compound was designed to be an alternative to the QAS-QPS tetramine. This compound has two amine sites for reacting with epoxide groups. This compound includes two phosphonium cationic sites and a single ammonium site. The anion Br is maintained consistent for comparison to the other compounds described herein. The compound includes a 10 carbon bridge between the ammonium and first phosphonium, with a 4 carbon bridge between the two phosphonium cationic centers. The compound was intended to act as a brush as in the PIP—C4-BIS-C3-NH₂ molecule with the end of the compound that is opposite the two amine groups extending away from the surface of the coating.

The trials completed on this molecule indicated poor biocidal activity in 5% FBS and MH Broth. Without being bound by any particular theory, this poor performance may be due to improper chain lengths and ratios between the cationic centers.

The PIP—C4-P—C4-P—C4-BIS-C3-NH₂ compound was designed to integrate the performance of the PIP—C4-BIS-C3-NH₂ with a QAS-QPS backbone. The compound was designed to include a piperidinyl structure to provide N-halamine precursor functionality. The counter ion was Br⁻. For relative comparison the same general structure as C4-P—C4-P—C10-BIS-C3-NH₂ was used with the exception of a four carbon bridge between the amine anchor branches. The additional ammonium is included for functional support in the biocidal activity.

This compound had biocidal activity in both 5% FBS and MH Broth. The compound is soluble in various solvents. The compound does not exhibit a zone of inhibition after 24 hours.

### Example 8A: Data Collected from Hard-Substrates Coated in Formulations from Example 7A

Table 40 summarizes the active chlorination results measured by iodometric titration performed on hard-substrates that were coated with the formulations of Example 7A and exposed to 200 ppm of chlorine for 10 minutes.

TABLE 40
Active chlorine results for various coated hard-substrates.

| Sample ID | μg/cm² | STDV |
|---|---|---|
| E16PDP19 | 6.67 | 1.55 |
| E16X2P21 | 11.85 | 3.84 |

Two different test methods were used to assess the biocidal activity of the hard substrates coated in the formulations of Example 7A, the ISO 22196 standard and a modified version of the ISO 22196 standard as described below.

Modified Technique 1: An overnight culture of E. coli was diluted to 10⁶ CFU/ml, and 200 μl was added onto 5 cm×5 cm of testing surface with a 4 cm×4 cm PET film.

Modified Technique 2: An overnight culture of E. coli was diluted to 10⁶ CFU/ml, and 50 μl was added onto a reduced surface area of greater than or equal to 2 cm×2 cm and covered with a 2 cm×2 cm PET film.

Modified Technique 3: An overnight culture of E. coli (10⁸⁻⁹ CFU/mL) in Nutrient Broth+5% FBS (No dilution). 20 μl of cultured E. coli at an approximate concentration of 10⁸⁻⁹ CFU/ml, was added onto 2.5 cm×2.5 cm of testing surface to achieve a final of 10⁶⁻⁷ CFU/carrier.

TABLE 41
Summarizes the biocidal activity of hard-substrates that were coated with the
E9PDP15 formulation or the E16X2P21 formulation, both are either chlorinated or
unchlorinated. The example data in Table 41 was obtained when the samples were
challenged with a 5% FBS organic load.

| | | | Log Reduction at Various Contact Times (Min) | | | | |
|---|---|---|---|---|---|---|---|
| | | | | | | | Full Log |
| | | | 5 | 10 | 20 | 30 | Reduction |
| Bacteria | | Sample ID | Log₁₀ | Log₁₀ | Log₁₀ | Log₁₀ | Log₁₀ |
| Gram- | E. coli | Unchlorinated | 0.58 | 0.72 | 1.22 | 1.93 | 5.57 |
| negative | ATCC | E16PDP19⁽¹⁾ | | | | | |
| | 25922 | Chlorinated | 0.26 | 0.72 | 1.98 | 5.57 | |
| | | E16PDP19⁽¹⁾ | | | | | |
| | | Unchlorinated | / | / | / | 0.60 | 5.40 |
| | | E16PDP19(A)⁽¹⁾ | | | | | |
| | | Unchlorinated | / | / | / | 0.44 | |
| | | E16PDP19(B)⁽¹⁾ | | | | | |
| | | Chlorinated | / | / | 1.35 | 5.40 | |
| | | E16PDP19(A)⁽¹⁾ | | | | | |
| | | Chlorinated | / | / | 2.11 | 5.40 | |
| | | E16PDP19(B)⁽¹⁾ | | | | | |
| | | Unchlorinated | 0.11 | 0.29 | / | 1.60 | 4.90 |
| | | E16X2P21⁽²⁾ | | | | | |
| | | Chlorinated | 0.49 | 1.97 | / | 4.90 | |
| | | E16X2P21⁽²⁾ | | | | | |
| | | Chlorinated | / | / | 5.11 | / | 5.11 |
| | | E16X2P21(A)⁽²⁾ | | | | | |
| | | Chlorinated | / | / | 5.11 | / | |
| | | E16X2P21(B)⁽²⁾ | | | | | |
| | | Chlorinated | / | / | / | 5.44 | 5.44 |
| | | E16X2P21(C)⁽¹⁾ | | | | | |
| | | Chlorinated | / | / | / | 5.44 | |
| | | E16X2P21(D)⁽¹⁾ | | | | | |

Note:
⁽¹⁾indicates samples that were evaluated against test ISO 22196 method using the Modified Technique 1, and
⁽²⁾indicates samples that were evaluated against test modified ISO 22196 method using the Modified Technique 2.

TABLE 42
Summarizes the biocidal activity of hard-substrates that were coated
with the E16PDP19 formulation or the E16X2P21 formulation, both
are either chlorinated or unchlorinated. The example data in Table 42
was obtained when the samples were challenged with a 100% MH
broth organic load and assessed using the ISO 22916
modified by technique 1.

| | | | Log Reduction | |
|---|---|---|---|---|
| | | | at 30 Min | |
| | | | | Full Log |
| | | | 30 | Reduction |
| Bacteria | | Sample ID | Log₁₀ | Log₁₀ |
| Gram- | E. coli | Chlorinated E16PDP19 (A)⁽¹⁾ | 0.77 | 5.51 |
| negative | ATCC | Chlorinated E16PDP19 (B)⁽¹⁾ | 0.58 | |
| | 25922 | Chlorinated E16X2P21 (A)⁽¹⁾ | 2.03 | 5.51 |
| | | Chlorinated E16X2P21 (B)⁽²⁾ | 2.23 | |

Note:
⁽¹⁾indicates samples that were evaluated against test ISO 22196 method using the Modified Technique 1, and
⁽²⁾indicates samples that were evaluated against test modified ISO 22196 method using the Modified Technique 2.

TABLE 43
Summarizes the biocidal activity of hard-substrates that were coated with the
E16X2P21 formulation, either chlorinated or unchlorinated. The example data in Table
42 was obtained when the samples were challenged with a 100% MH broth organic
load and assessed using the ISO 22916 modified by technique 1.

| | | | Log Reduction at Various Contact Times (Min) | | | |
|---|---|---|---|---|---|---|
| | | | | | | Full Log |
| | | | 5 | 15 | 30 | Reduction |
| Bacteria | | Sample ID | Log₁₀ | Log₁₀ | Log₁₀ | Log₁₀ |
| Gram- | E. coli | Unchlorinated E16X2P21⁽¹⁾ | 0.74 | 1.00 | 0.88 | 6.75 |
| negative | ATCC | Chlorinated E16X2P21⁽¹⁾ | 0.25 | 0.91 | 6.75 | |
| | 25922 | | | | | |

TABLE 44
Summarizes the relative protein adsorption on to the surface of the
coatings. This test method is based on a commercially available
Lowry/BCA assay kit to measure the concentration of eluted
protein from the polymeric surface. The testing was completed
against MH Broth and 5% FBS as the organic load.

| Test | Organic | E16PDP19 | E16X2P21 |
|---|---|---|---|
| Set | Load | ug/cm2 | ug/cm2 |
| A | MH | 19.67 | 3.83 |
| | broth | | |
| | 5% FBS | 65.50 | 50.92 |
| B | MH | 20.5 | 6.75 |
| | broth | | |
| | 5% FBS | 63.83 | 25.08 |

It is generally understood that a lower level of protein adsorption reflects a coating that may be less susceptible to organic load interference of biocidal activity or other desired properties.

### Example 9: Data Collected from Non-Porous Hard Substrate Coated in Eleventh Coating Formulation

The eleventh coating formulation that comprised the compound of Formula 8J was dissolved in methanol, coated on galvanized steel using a 3 millimeter draw down bar and left to cure at room temperature.

TABLE 45
Summarizes the formulation of the eleventh coating-composition.

| Eleventh Coating-Composition | Mass (g) | % (wt/wt) |
|---|---|---|
| AA007 (Formula 8J) | 2.1 | 44.03% |
| Solvent: Methanol | 2.6 | 54.51% |
| diethylenetriamine (DETA) | 0.07 | 1.47% |
| Totals | 4.77 | 100 |

This coated substrate was then exposed to 200 ppm of chlorine for ten minutes and using the titration methodologies described above, an active chlorine loading of 19.23 μg/cm² was observed. A positive charge was quantified on the surface of the halogenated and coated substrate using the methodologies described above, a charge density of 7.18 E+15 (N+/cm²) was observed.

Employing the ISO 22196 methodology, the coated (in the eleventh coating formulation) and halogenated non-porous hard substrate was tested for biocidal activity with a 5% FBS organic load challenge. FIG. 6 shows an example of the log-reduction in E. coli following a one-hour time course. The dashed line is data observed from the chlorinated sample and the solid line is data observed from the unchlorinated sample.

Furthermore, the coated non-porous hard substrate did not exhibit any zone of inhibition after 3, 7 or 24 hours of incubating in water, which is taken as a lack of leaching of the eleventh coating formulation.

I claim:

1. A compound with a general formula: 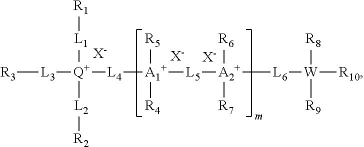
wherein L₁, L₂, L₃, L₄, L₅ and L₆ are independently selected from a group comprising: a chain of the formula C_{b}H_{(2b)} where b is an integer between 0 and 24; triazole, heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline; any combination thereof or nil;
wherein at least one of R₁, R₂ and R₃ is an N-halamine precursor that is selected from a group comprising imidazolidine-2,4-dione (hydantoin); 5,5-dimethylhydantoin; 4,4-dimethyl-2-oxazalidione; tetramethyl-2-imidazolidione; 2,2,5,5-tetramethylimidazo-lidin-4-one; a uracil derivative; and piperidine, including 2,2,6,6-tetramethyl-piperidine, wherein if any of R₁, R₂ or R₃ are not an N-halamine precursor then they are independently selected from H, an alkyl chain of the formula C_{b1}H_{(2b1+1)} where b1 is an integer between 0 and 24, a cyclic organic group including ring structures with at least four carbons and nil;
wherein Q⁺, A₁⁺ and A₂⁺ are each a cationic center that is independently selected from the group of N, P, S or nil;
wherein R₄, R₅, R₆ and R₇ are independently selected from an alkyl chain of the formula C_{b2}H_{(2b2+1)} where b2 is an integer between 0 and 24 with a further terminal-group of Q⁺; heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline;
wherein if Q⁺ is S, then at least one of L₁, L₂ or L₃ are nil;
wherein if A₁⁺ is S, then at least one of R₄ or R₅ is nil;
wherein if A₂⁺ is S, then at least one of R₆ or R₇ is nil;
wherein X⁻ is a counter ion selected from a group of Cl⁻, Br⁻, I⁻, F⁻, CH₃CHOO⁻, ⁻OOCCOO⁻, ⁻OOC(CH₂)4COO⁻, CF3COO⁻, BF₄⁻, PF₆⁻, ClO₄⁻, SO₄²⁻, NO₃⁻, OH⁻, CO₃²⁻ PO₄³⁻; or bis(trifluoromethanesulfonyl)amide⁻;
wherein m is an integer selected from 0 to infinity and if m is greater than 2 then between each unit of m each of R₄, R₅, R₆, R₇, A₁⁺, A₂⁺ and L₅ can be the same or different;
wherein W is selected from the group of P⁺, N⁺, S⁺, N, C, Si, O, heterocyclic aliphatics or homocyclic aliphatics, including cyclohexane and cyclopentane, heterocyclic aromatics or homocyclic aromatics, including phenyl, benzyl, pyridinyl, pyrimidinyl, imidazol, imidazoline or another moiety that is capable of bonding with 1, 2, 3 or more further moieties, such further moieties including H, alkyl chains of formula C_{b3}H_{(2b3+0)} where b3 is an integer between 0 and 24, alkene chains of formula C_{b4}H_{(2b4)} where b4 is an integer between 0 and 24, alkyne chains of formula C_{b5}H_{(2b5-2)} where b5 is an integer between 0 and 24, or otherwise;
wherein R₈, R₉ and R₁₀ are each selected from a group comprising: C_{b6}H_{(2b6)} where b6 is an integer between 0 and 24, phenyl, benzyl, n,n-dimethyl-4-amino-pyridine, vinylbenzyl, C₃H₆NH₂, CH₂CH₂OH, CH₂CH₂═CH₂, CH₂C≡CH, CzH_{(2z+1)}R₁₃, 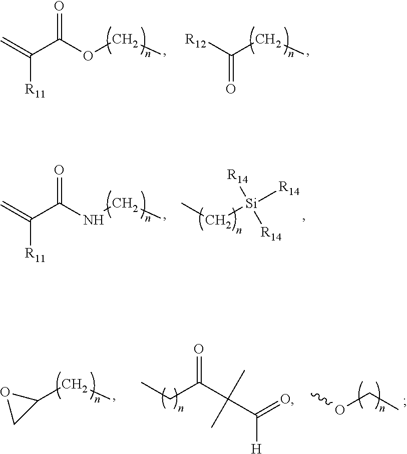
wherein z is an integer selected from 0 to 24;
wherein n is an integer selected from 0 to 24;
wherein R₁₁ is selected from H, CH₃ and CN;
wherein R₁₂ is selected from H, OH, NH₂, O(CH₂)ₚCH₃, alkoxy group of O-alkyl chains of formula CₚH₍₂ₚ₊₁₎ where p is an integer between 0 and 24 and positional isomers of primary, secondary or tertiary alkyl chains;
wherein R₁₃ may be selected from anyone of OH, SH, COOH, CONH₂, OCN, CN, NC, SCN, and NCS
wherein R₁₄ may be selected from anyone of OH, alkoxy group of O-alkyl chains of formula C_{q}H_{(2q+1)} where q is an integer between 0 and 24 and positional isomers of primary, secondary or tertiary alkyl chains;
and
wherein when W is S⁺, at least one of R₈, R₉ and R₁₀ is nil and the other two moieties together with S⁺ may form one of

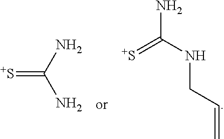

2. The compound of claim 1 with a general formula:

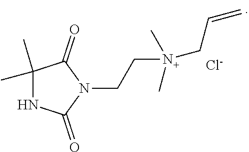

3. The compound of claim 1 with a general formula:

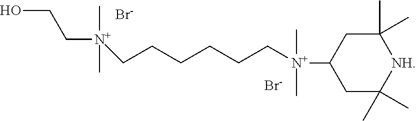

4. The compound of claim 1 with a general formula:

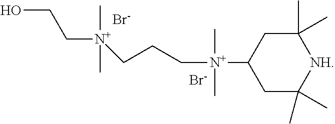

5. The compound of claim 1 with a general formula:

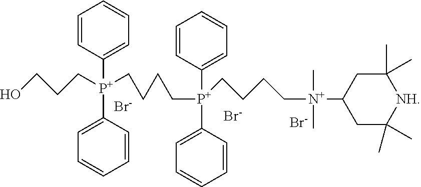

6. The compound of claim 1 with a general formula:

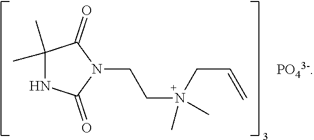

7. The compound of claim 1 with a general formula:

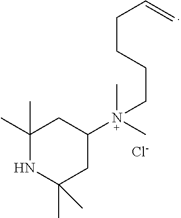

8. The compound of claim 1 with a general formula:

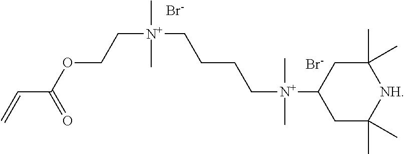

9. The compound of claim 1 with a general formula:

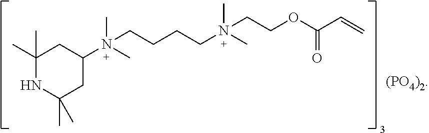

10. The compound of claim 1 with a general formula:

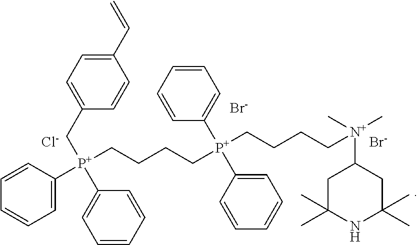

11. The compound of claim 1 with a general formula:

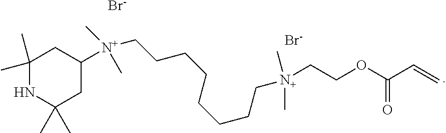

12. The compound of claim 1 with a general formula:

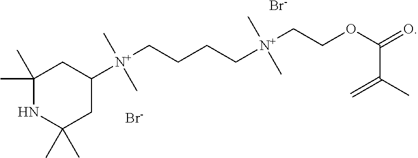

13. The compound of claim 1 with a general formula:

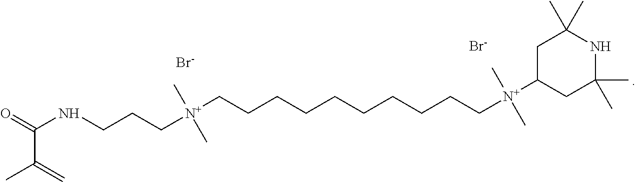

14. The compound of claim 1 with a general formula:

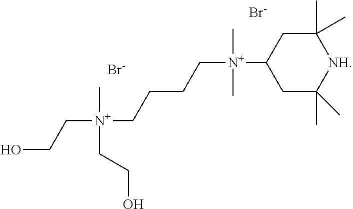

15. The compound of claim 1 with a general formula:

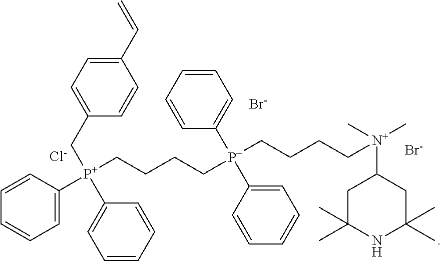

16. The compound of claim 1 with a general formula:

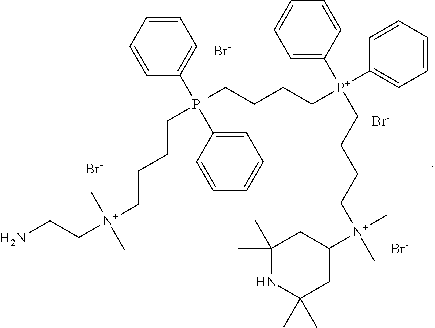

17. The compound of claim 1 with a general formula:

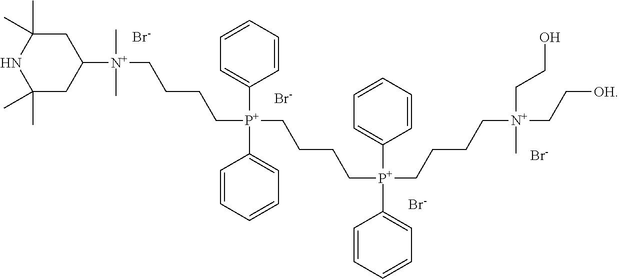

18. The compound of claim 1 with a general formula:

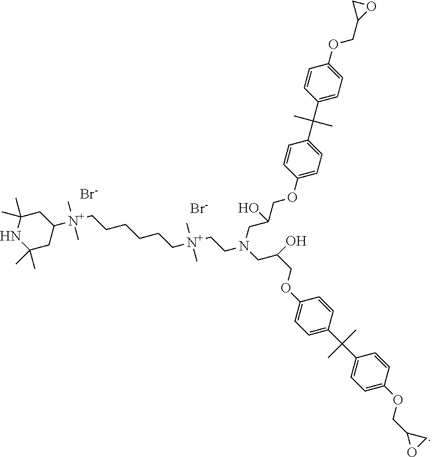

19. The compound of claim 1 with a general formula:

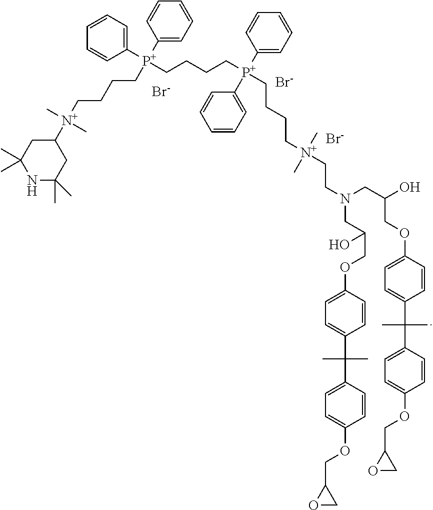

20. The compound of claim 1 with a general formula:

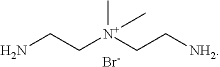

21. The compound of claim 1 with a general formula:

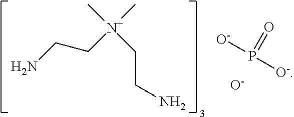

22. The compound of claim 1 with a general formula:

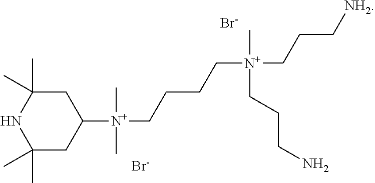

23. The compound of claim 1 with a general formula:

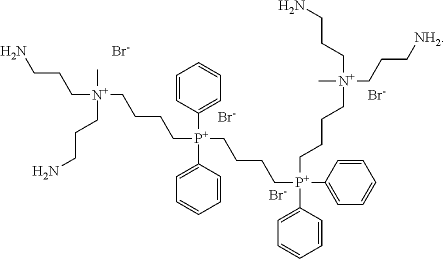

24. The compound of claim 1 with a general formula:

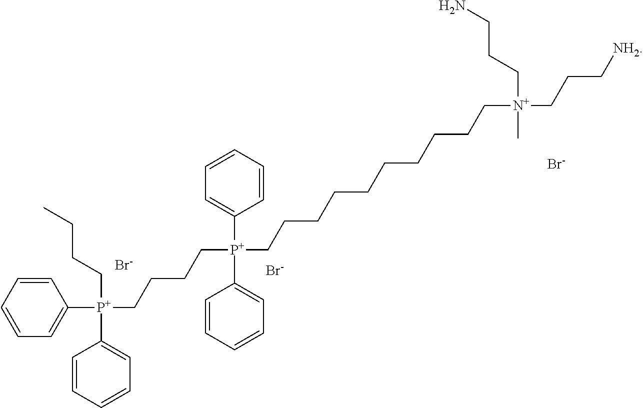

25. The compound of claim 1 with a general formula:

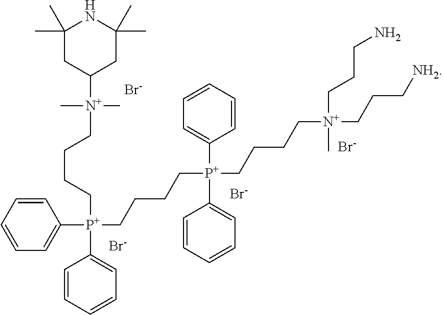

26. The compound of any one of claims 1 to 19, 22 and 25 wherein the N-halamine precursor is replaced by an N-halamine.

27. A coating composition comprising the compound of any one or claims 1 to 26, wherein the coating composition has biocidal activity or the potential for biocidal activity.

28. The coating composition of claim 27 further comprising a binding agent.

29. Use of the coating composition of claim 27 or claim 28 for coating a substrate, wherein the substrate may be selected from a group comprising: a textile, a metal, a metal alloy, a polymer, glass, a natural substance, such as wood, and a combination thereof.

30. A method of coating a substrate, the method comprising steps of:
a. wetting at least one surface of the substrate with the coating composition of claim 27 or claim 28; and
b. drying the coating composition upon the at least one surface of the substrate.

31. The method of claim 30, further comprising a step of curing the coating composition at room temperature or with a temperature that is higher than room temperature.

32. The method of claim 30 or claim 31, further comprising a step of exposing the at least one surface to one or more halogens.

33. A substrate comprising at least one surface that is coated with the coating composition of claim 27 or claim 28.

34. The substrate of claim 33, wherein the coating is polymer-based.

35. The substrate of claim 33 or claim 34, wherein the substrate forms at least part of a surface selected from a group of surfaces consisting of: a surgical equipment surface, a surface of protective apparel for use in health-care settings, a surface of a medical implant, a surface of a medical device, a surface of a biosensor, a surface of a textile, a surface used for food preparation, a surface used in food packaging, a surface used in food storage, a surface of a water-purification system, a surface of a water-treatment system, a surface of marine equipment, a surface of industrial equipment, a surface of equipment used in the oil-and-gas industry, a surface of agricultural equipment, a surface used in husbandry and combinations thereof.
